(19) United States
(12) Patent Application Publication
(10) Pub. No.: US 2008/0114635 A1
(43) Pub. Date: May 15, 2008

(54) Method and apparatus for calculating importance degrees for resources

(75) Inventors: Soichi Shigeta, Kawasaki (JP); Hiromichi Kobashi, Kawasaki (JP); Haruyasu Ueda, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/895,007

(22) Filed: Aug. 22, 2007

(30) Foreign Application Priority Data
Nov. 14, 2006 (JP) 2006-307382

(51) Int. Cl. G05B 19/418

(52) U.S. Cl. 705/8

(57) ABSTRACT

A method for calculating an importance degree for a resource according to this invention includes: receiving a first importance degree assigned to a resource node to be allocated or having been allocated to a specific business service based on an original policy in the specific business service; and converting the received first importance degree to a second importance degree in an entire system according to data concerning an importance degree re-calculation policy, which is set for the specific business service independently of the original policy. Because the second importance degree in the entire system is re-calculated according to the importance degree re-calculation policy, it is possible for an operation administrator of the entire system to flexibly and appropriately set the importance degree re-calculation policy so as to optimize the resource allocation of the entire system.

### TECHNICAL FIELD OF THE INVENTION

This invention relates to a technique for calculating importance degrees for resources to be allocated or having been allocated to a business service.

### BACKGROUND OF THE INVENTION

In a distributed computing environment in which the resources are shared and used in plural business services, it is desired that the resource allocation for each of the business services is optimized. A method for adjusting the resource allocation based on the statically defined priority of the business service has already been known. Furthermore, a method is proposed in which a resource manager of a business service is caused to determine the importance degree of the resource allocated to the pertinent business service, and the global adjustment of the resource allocation based on their importance degrees is carried out.

For example, as shown in FIG. 1, an administrator of a business service 1 carries out a setting of a Business Value (BV) calculation policy of the business service 1 for a BV calculation apparatus of a local optimization mechanism for the business service 1. The BV calculation apparatus assigns BVs (importance degree of the business service) from 20 to 60 to the resource nodes for the business service 1 according to the setting of the BV calculation policy. Specifically, two resource nodes of BV=20, one resource node of BV=50, and one resource node of BV=60 are secured.

Similarly, an administrator of a business service 2 carries out the setting of the BV calculation policy of the business service 2 for a BV calculation apparatus of a local optimization mechanism for a business service 2. The BV calculation apparatus assigns the BV from 50 to 100 to the resource nodes for the business service 2 according to the setting of the BV calculation policy. Specifically, one resource node of BV=60, one resource node of BV=80 and one resource node of BV=90 are secured.

When actually accepting the allocation of the resource nodes, the local optimization mechanisms of the business services 1 and 2 notify a global optimization mechanism of the BVs. The global optimization mechanism allocates the resource nodes according to settings of its operation administrator. In the example of FIG. 1, by using BVs from the local optimization mechanisms as they are, the resource nodes are allocated. The BVs are assigned by the global optimization mechanism in a range from 0 to 100. Here, there are 7 resource nodes, and 4 resource nodes are allocated to the business service 1, and three resource nodes are allocated to the business service 2.

Here, as shown in FIG. 2, when the business service 2 requests one resource node of BV=50, because there is no unused resource node, the resource node of the smallest BV (here, the resource node of BV=20, which is allocated to the business service 1) is transferred to the business service 2 relating to this request.

In the conventional art, the administrators of respective business services and the operation administrator of the global optimization mechanism separately make agreements so that an appropriate BV is output in each local optimization mechanism. That is, it is impossible to carry out the complete optimization only by the global optimization mechanism.

Incidentally, the aforementioned system is disclosed in the following paper: Haruyasu Ueda, Nobutaka Imamura, Hiromichi Kobashi, Soichi Shigeta, Miho Murata, Akira Asato and Yoshimasa Kadooka, “Grid Service Platform: A Prototype to Share Computational Resources for Business Operation Services”, proceedings of the Conference on Computational Engineering and Sciences, Vol. 11, No. 2, pp 531-534 (2006, July).

In this conventional art, because not only the reference and/or strategy to calculate the importance degree of the specific business service but also the setting of the range of the importance degree, which is used by the specific business service, (relative magnitude correlation of the importance degree of the specific business service and the importance degrees of other business services) are also made by the administrator of the specific business service, the following problems occur. That is, (1) the operation administrator of the global optimization mechanism cannot directly change the relative importance degree of the business service, and when changing the relative importance degree of each business service in order to deal with the change of the operational state, he or she cannot change the relative importance degree immediately. (2) When setting the BV calculation policy for the BV calculation apparatus of the specific business service, it is necessary for the administrator of the specific business service to obtain the agreement about the importance degree of the specific business service with the operation administrator (and the administrators of the other business services) in advance. That is, a lot of human works are required for the setting of the BV calculation policy of the local optimization mechanism. (3) Because the administrators of the business services and management hosts are located in a geographically dispersive manner, a lot of human works are required for the grasp and management of the relative importance degree of the entire business service and they are difficult. (4) It is impossible to prevent a wrong importance degree from being used when an inappropriate BV calculation policy is set for the BV calculation apparatus of the specific business service due to a mistake or intention of the administrator of the specific business service. That is, it is impossible to prevent the importance degree of the specific business service from unreasonably becoming relatively lower or higher than that of the other business services.

Furthermore, (5) even when the distribution of the BVs assigned to the resources allocated to a business service has a bias because the BV calculation policy set for the BV calculation apparatus of the business service by the administrator of the business service is improper, it is impossible to correct the BV calculation policy.

### SUMMARY OF THE INVENTION

Therefore, an object of this invention is to provide a technique enabling to flexibly and appropriately set the importance degree for the resource node to be allocated or having been allocated to the business service in the distributed computing environment in which the plural business service shares the resources.

In addition, another object of this invention is to provide a technique to appropriately allocate the resource nodes even when the importance degree assigned to the resource node in the business service is improper.

A method for calculating an importance degree for a resource according to this invention includes: receiving a first importance degree assigned to a resource node to be allocated or having been allocated to a specific business service based on an original policy in the specific business service; and converting the received first importance degree to a second importance degree in an entire system according to data concerning an importance degree re-calculation policy, which is set for the specific business service independently of the original policy and stored in a policy storage, and storing the second importance degree into a storage device.

Because the second importance degree in the entire system is re-calculated according to the importance degree re-calculation policy, it is possible for the operation administrator of the entire system to flexibly and appropriately set the importance degree re-calculation policy so as to optimize the resource allocation of the entire system. Here, the optimization means that effects and gains obtained from plural business services are maximized when carrying out all those business services by using the limited number of resource nodes, which exist in the system.

Incidentally, this invention may further include switching the importance degree re-calculation policy for the specific business service. For instance, there is a case where it is necessary to apply the different importance degree re-calculation policies at daytime and night, and it becomes possible to flexibly deal with such a case by carrying out such a processing.

Furthermore, the importance degree re-calculation policy may be at least one of a method for causing to carry out a section compression and a section shift, a method for mapping values to discontinuous predetermined values, and a method using a predetermined function.

In addition, the importance degree re-calculation policy may include a rule concerning a range of the second importance degree. By carrying out such a processing, even when an inappropriate importance degree is received, the correction can be made by this processing.

Furthermore, this invention may further include: judging whether or not distribution of the received first importance degrees is deviated from a reference, which is defined in advance and is stored in a distribution adjustment data storage; and when it is judged that the distribution of the received first importance degrees is deviated from the reference, correcting the distribution of the received first importance degrees.

In addition, the aforementioned correcting may include: invalidating the importance degree re-calculation policy; and correcting the received first importance degree so that the corrected first importance degrees distribute according to distribution stored in the distribution adjustment data storage. This is because, when the received first importance degree has an offset, problems occur in which the resources are unreasonably occupied, and the service is not carried out infinitely.

Furthermore, the aforementioned correcting may include: when a difference between an average value of the received first importance degrees and a reference stored in the distribution adjustment data storage is equal to or greater than a predetermined value, correcting the received first importance degree according to the difference. By carrying out such correction, the importance degree can be made within an appropriate range.

Incidentally, it is possible to create a program for causing a computer to execute the method for calculating the importance degree for the resources according to the present invention. The program is stored into a storage medium or a storage device such as, for example, a flexible disk, a CD-ROM, a magneto-optical disk, a semiconductor memory, or a hard disk. In addition, the program may be distributed as digital signals over a network in some cases. Data under processing is temporarily stored in the storage device such as a computer memory.

### BRIEF DESCRIPTION OF THE DRAWINGS

FIG. 1 is a diagram to explain a conventional art;

FIG. 2 is a diagram to explain the conventional art;

FIG. 3 is a system outline diagram in an embodiment of this invention;

FIG. 4 is a diagram showing a relation between a local optimization mechanism and a global optimization mechanism;

FIG. 5A is a functional block diagram of the global optimization mechanism;

FIG. 5B is a diagram showing a local BV distribution monitoring table;

FIG. 5C is a diagram showing a distribution adjustment policy table;

FIG. 5D is a diagram showing a BV re-calculation policy table;

FIG. 5E is a diagram showing a resource management table;

FIG. 5F is a diagram showing a resource request management table;

FIG. 5G is a diagram showing an allocation change management table;

FIG. 6A is a sequence diagram in the switching of the resource allocation;

FIG. 6B is a sequence diagram in the switching of the resource allocation;

FIG. 7 is a sequence diagram in the update of the local BV;

FIG. 8 is a diagram showing a processing flow of a processing to convert the local BV to the global BV;

FIG. 9A is a diagram showing an example to calculate the local BV from the state of the processing;

FIG. 9B is a diagram showing the relationship among the state of the processing, the local BV and the global BV in a method of “section compression+section shift”;

FIG. 10A is a diagram showing another example to calculate the local BV from the state of the processing;

FIG. 10B is a diagram showing the relationship among the state of the processing, the local BV and the global BV in the method of “section compression+section shift”;

FIG. 11 is a diagram showing an example of a method of “mapping to discontinuous values”;

FIG. 12 is a diagram showing an example of a function definition method;

FIG. 13 is a diagram showing another example of the function definition method;

FIG. 14A is a diagram showing a method for converting the local BV in the daytime of the weekday to the global BV, and FIG. 14B is a diagram showing a method for converting the local BV in the night or the holiday to the global BV;

FIG. 15 is a diagram showing an example of the resource allocation in this embodiment;

FIG. 16 is a diagram showing an example of the resource allocation in this embodiment;

FIG. 17 is a diagram showing an example of the resource allocation in this embodiment;

FIG. 18 is a diagram showing an example of the resource allocation in this embodiment;

FIG. 19 is a diagram showing an example of the resource allocation in this embodiment;

FIGS. 20A to 20C are diagrams to explain inappropriate distribution of the local BV;

FIGS. 21A and 21B are diagrams to explain the distribution correction of the local BV;

FIG. 22 is a diagram showing a processing flow of a correction processing of the local BV distribution; and

FIG. 23 is a functional block diagram of a computer.

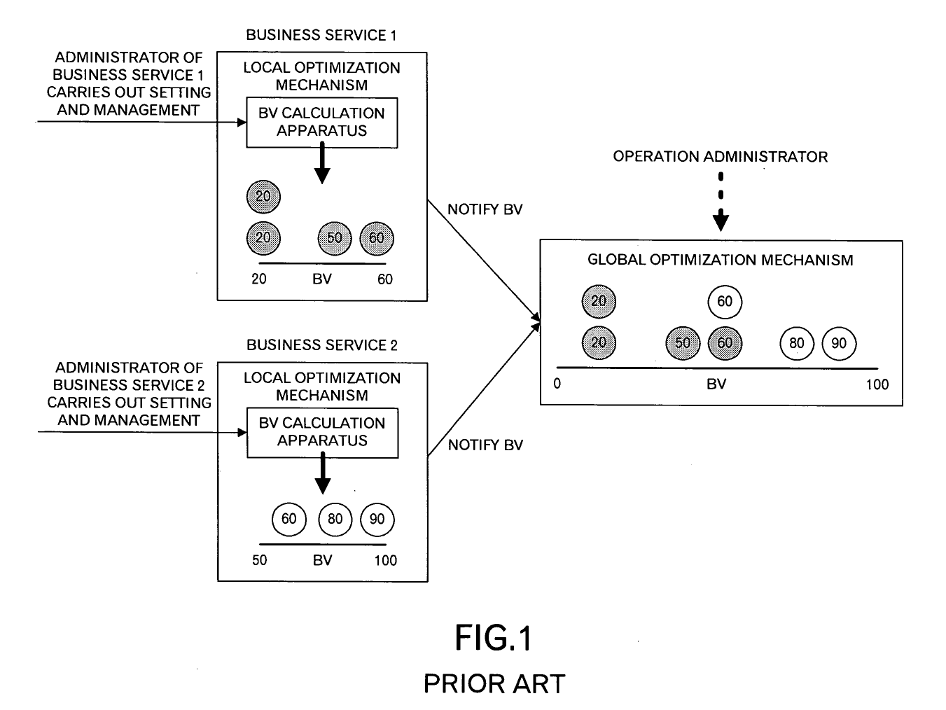

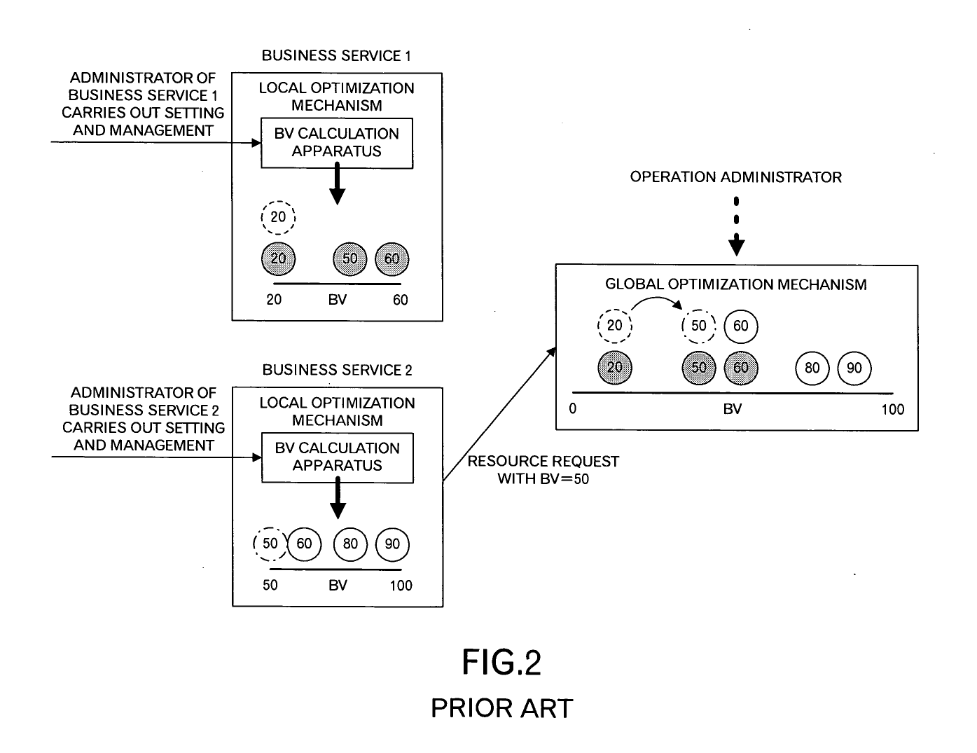

### DETAILED DESCRIPTION OF THE PREFERRED EMBODIMENTS

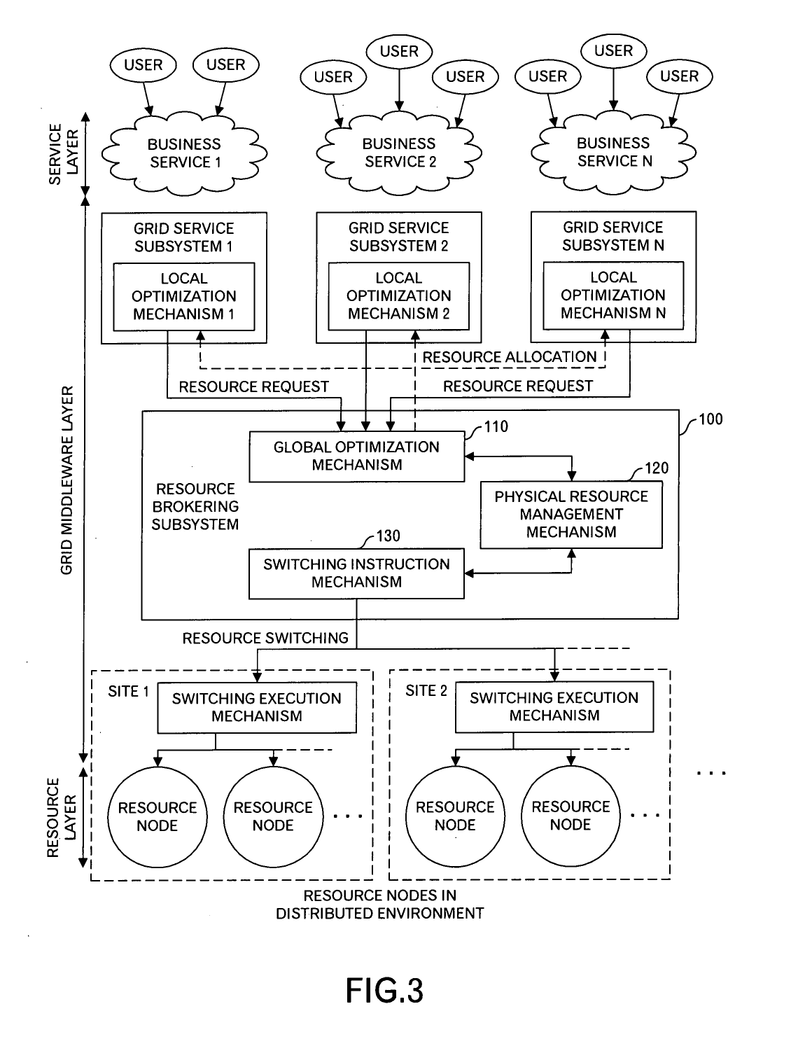

FIG. 3 shows an entire system according to an embodiment of this invention. As shown in FIG. 3, a distributed computing environment in which plural business services (business services 1 to N) share plural resource nodes included in plural sites is assumed. Such a distributed computing environment is divided into a service layer, a grid middleware layer and a resource layer, and the service layer contains respective business services utilized by plural users, the resource layer contains respective resource nodes, and the grid middleware layer contains a mechanism to effectively allocate the resource nodes to respective business services. Specifically, the grid middleware layer includes grid service subsystems containing local optimization mechanisms corresponding to respective business services, a resource brokering subsystem 100 to determine the resource allocation for the entire system, and switching execution mechanisms in respective sites. The resource brokering subsystem 100 includes a global optimization mechanism 110, a physical resource management mechanism 120 and a switching instruction mechanism 130.

For example, when the resource is acquired in the business service 1 based on a request from a user, a BV (called as a local BV) for the resource to be acquired is calculated according to a predetermined policy in the local optimization mechanism 1 of the grid service subsystem 1, and a resource request including the calculated local BV is output to the global optimization mechanism 110 of the resource brokering subsystem 100. The global optimization mechanism 110 converts the local BV to a global BV according to a preset importance degree re-calculation policy, and determines the resource allocation according to the global BV. When the resource allocation is carried out, a notification as to the resource allocation is notified to the local optimization mechanism 1 of the requesting source. In addition, the global optimization mechanism 110 outputs the result of the resource allocation to the physical resource management mechanism 120. When the switching of the resource occurs, the physical resource management mechanism 120 determines to which resource node the business service is allocated physically, and outputs an instruction about the allocation to the switching instruction mechanism 130. The switching instruction mechanism 130 outputs an instruction to the effect that the requested business service is allocated to a specific physical resource node relating to the instruction from the physical resource management mechanism 120, to a pertinent switching execution mechanism. The pertinent switching execution mechanism causes the resource node to switch a processing to be executed, according to the instruction from the switching instruction mechanism 130.

This embodiment mainly relates to the local optimization mechanisms of the grid service subsystems corresponding to respective business services and the global optimization mechanism 110 of the resource brokering subsystem 100. Therefore, further explanation for other portions will be omitted.

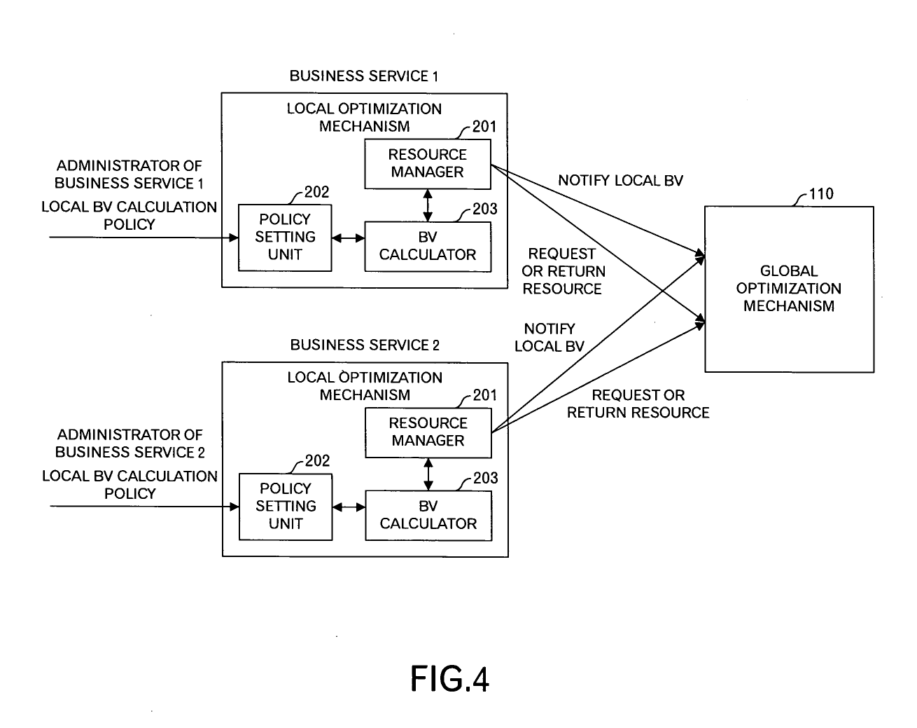

Next, a configuration of the local optimization mechanism will be mainly explained with reference to FIG. 4. The local optimization mechanism of each business service includes a policy setting unit 202 that accepts an input of the local BV calculation policy by the administrator of the business service and stores the local BV calculation policy; a BV calculator 203 that calculates the local BV for a resource node to be allocated or having been allocated to the business service based on the local BV calculation policy set into the policy setting unit 202; and a resource manager 201 that manages the resource nodes used by this business service, and sends the local BV calculated by the BV calculator 203 to the global optimization mechanism 110 as a notification of the local BV or a resource request (there is also a case of the resource return.).

The original local BV calculation policy is set to the policy setting unit 202 of the local optimization mechanism according to the business service, and the BV calculator 203 calculates the local BV according to the original local BV calculation policy. In the conventional art, after the operation administrator of the global optimization mechanism 110 and the administrators of the respective business services confer, the local BV calculation policies (e.g. distribution) in the local optimization mechanisms and the like were determined and set. However, in this embodiment, because the global optimization mechanism 110 carries out the adjustment for the entire system according to settings of the operation administrator in the global optimization mechanism 110, the local BV is calculated according to the original local BV calculation policy in the local optimization mechanism. For example, the local BV from 1 to 100 is calculated. However, as described below, when the local BV is calculated in extremely biased distribution, the global optimization mechanism 110 forcibly correct the biased local BV.

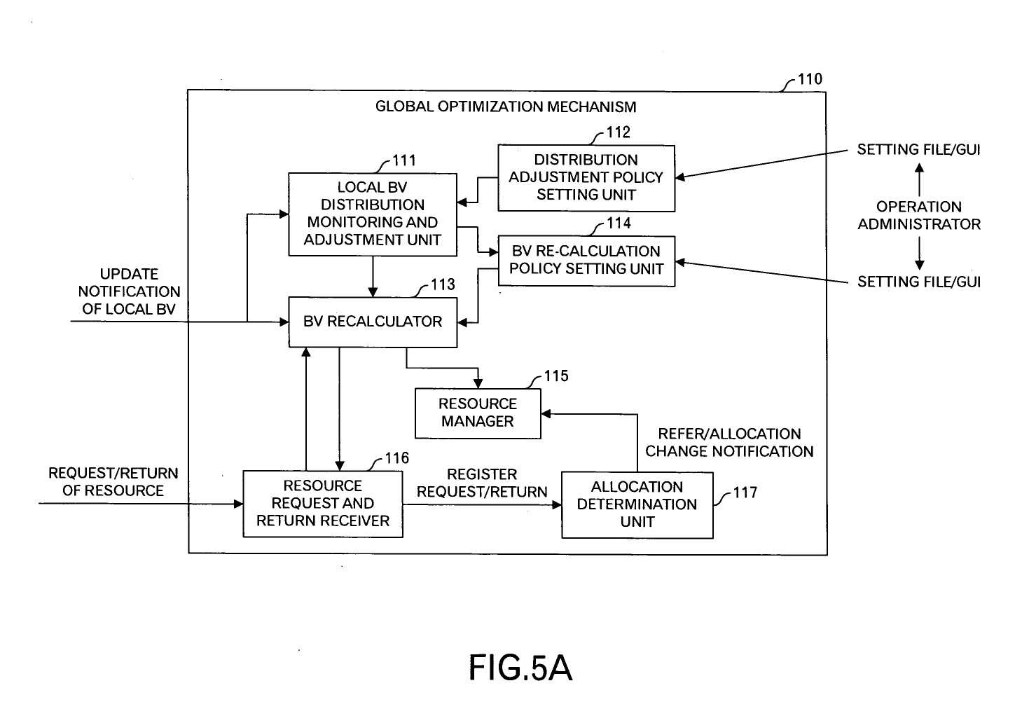

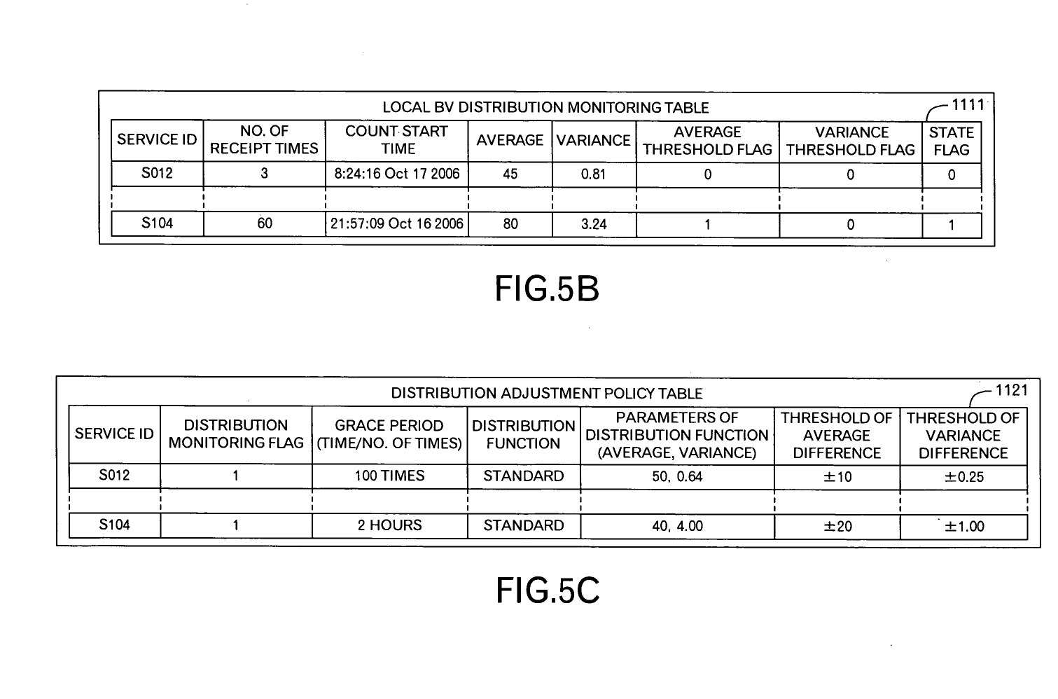

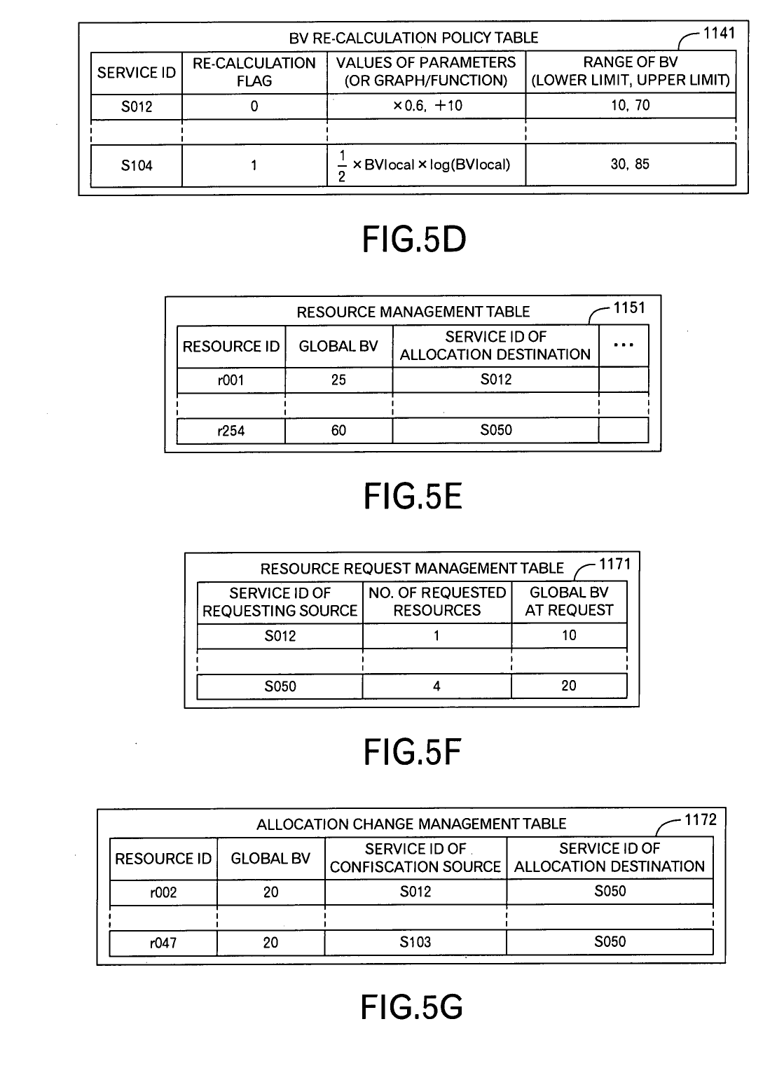

Next, a specific configuration of the global optimization mechanism 110 will be explained by using FIG. 5A. The global optimization mechanism 110 has a local BV distribution monitoring and adjustment unit 111 having a local BV distribution monitoring table 1111 (FIG. 5B); a distribution adjustment policy setting unit 112 having a distribution adjustment policy table 1121 (FIG. 5C); a BV recalculator 113; a BV re-calculation policy setting unit 114 having a BV re-calculation policy table 1141 (FIG. 5D); a resource manager 115 having a resource management table 1151 (FIG. 5E); a resource request and return receiver 116; and an allocation determination unit 117 having a resource request management table 1171 (FIG. 5F) and an allocation change management table 1172 (FIG. 5G).

The local BV distribution monitoring and adjustment unit 111 receives an update notification (including the service ID, local BV and resource ID) of the local BV from the local optimization mechanism of each business service, and carries out a processing relating to the update notification. At the processing, it refers to the distribution adjustment policy table 1121. In addition, if necessary, it causes the BV re-calculation policy setting unit 114 to carry out settings. Furthermore, when it carried out the adjustment of the local BV, it outputs the adjustment result to the BV recalculator 113.

The local BV distribution monitoring table 1111 stores, for each service ID, the number of receipt times, a count start time, an average, a distribution, a threshold flag of the average, a threshold flag of the variance and a state flag. Because the count start time is used in order to calculate the time from the count start, it is possible to hold an elapsed time itself while independently updating it.

As shown in FIG. 5A, the distribution adjustment policy setting unit 112 receives a setting file from the operation administrator of the global optimization mechanism 110, or displays a setting screen (GUI: Graphical User Interface) on a display device and causes the operation administrator to input data, and stores the received data into the distribution adjustment policy table 1121. As shown in FIG. 5C, the distribution adjustment policy table 1121 stores, for each service ID, a distribution monitoring flag representing whether or not the distribution monitoring and adjustment are carried out, a grace period (time/the number of times), a preferable distribution function, parameters (average, variance and the like) of the preferable function, a threshold of an average difference, and a threshold of a variance difference.

The BV re-calculation policy setting unit 114 receives a setting file from the operation administrator of the global optimization mechanism 110, or displays a setting screen on a display device to cause the operation administrator to input data, and stores the received data into the BV re-calculation policy table 1141. As shown in FIG. 5D, the BV re-calculation policy table 1141 stores, for each service ID, a re-calculation flag representing whether or not the re-calculation is carried out, values of parameters (e.g. a section compression ratio and a section shift value, or graph/function), and a BV range (lower limit value and upper limit value).

The BV recalculator 113 receives the update notification of the local BV from the local optimization mechanism of each business service, and carries out a processing to convert the local BV into the global BV based on data stored in the BV re-calculation policy table 1141. Incidentally, there is a case where a processing for the local BV included in the resource request is carried out. When the update notification of the local BV is received, the calculated global BV is output to the resource manager 115.

The resource manager 115 updates the resource management table 1151 in response to an instruction from the BV recalculator 113 or the allocation determination unit 117. As shown in FIG. 5E, the resource management table 1151 registers, for each resource ID, the global BV and the allocation destination service ID.

When the resource request and return receiver 116 receives a resource request including the local BV from the local optimization mechanism of each business service, the resource request and return receiver 116 requests the BV recalculator 113 to calculate the global BV, and outputs a resource request including the global BV to the allocation determination unit 117. When receiving a resource return request including the resource ID from the local optimization mechanism of each business service, the resource request and return receiver 116 outputs the resource return request to the allocation determination unit 117.

The allocation determination unit 117 receives the resource request including the global BV via the resource request and return receiver 116, and registers the request into the resource request management table 1171, and refers to the resource management table 1151 managed by the resource manager 115 to judge whether or not the resource allocation should be changed. In a case where the resource allocation is switched, such as a case where the global BV relating to the resource request is greater than the minimum global BV among the resources, which are currently allocated, the allocation determination unit 117 refers to the allocation change management table 1172 to confirm that the resource having the minimum global BV is not in the switching, and after that, the allocation determination unit 117 registers data concerning the switching into the allocation change management table 1172. When the switching of the resource allocation is completed, the allocation determination unit 117 instructs the resource manager 115 to carry out the change of the resource management table 1151. Incidentally, when the switching is carried out, the pertinent records, which are registered in the resource request management table 1171 and the allocation change management table 1172, are invalidated. On the other hand, when receiving the resource return including the resource ID via the resource request and return receiver 116, the allocation determination unit 117 causes the resource manager 115 to register the release of the resource relating to the return into the resource management table 1151. In addition, the allocation determination unit 117 causes the resource manager 115 to register the allocation of the vacant resource to the business service whose global BV is the maximum value in the resource request management table 1171 to the resource management table 1151.

As shown in FIG. 5F, the resource request management table 1171 stores a requesting source service ID, the number of requested resources, and the global BV at the request. In addition, as shown in FIG. 5G, the allocation change management table 1172 stores the resource ID, the global BV, the service ID of the confiscation source and the service ID of the allocation destination.

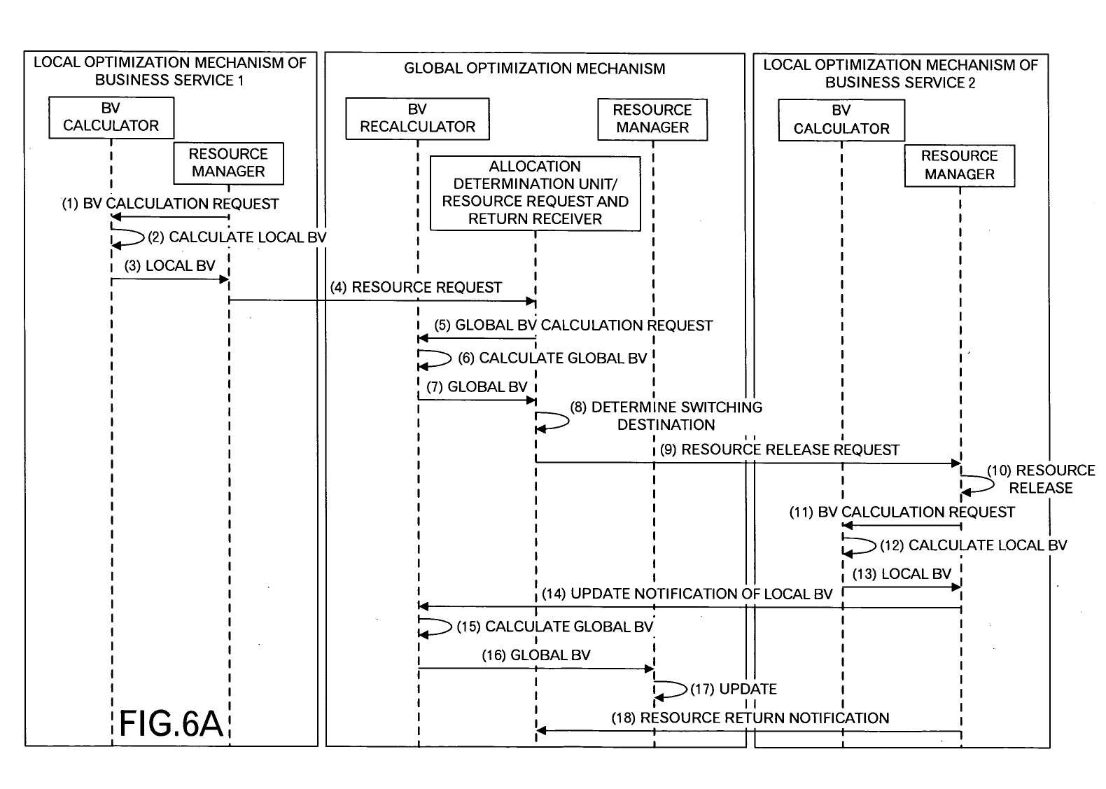

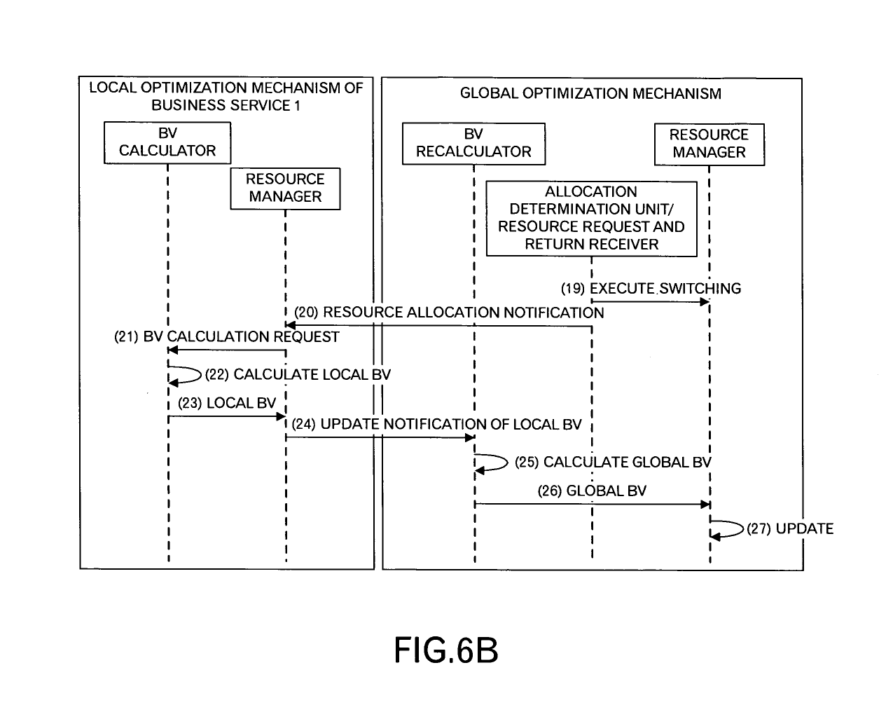

Incidentally, because, in this embodiment, the resource manager 115, the resource request and return receiver 116 and the allocation determination unit 117 are not main portions, their specific operations are explained only by using FIGS. 6A and 6B.

By using FIG. 6A, a case where the resource allocated to the business service 2 is transferred according to the resource request from the business service 1 will be explained. First, the resource manager 201 of the local optimization mechanism of the business service 1 outputs a BV calculation request to the BV calculator 203 before the resource request is transmitted to the global optimization mechanism 110 (step (1)). The BV calculator 203 receives the BV calculation request from the resource manager 201, calculates the local BV according to the policy (e.g. a predefined function of the number of sessions and the local BV or the like) set in the policy setting unit 202 (step (2)), and outputs the local BV to the resource manager 201 (step (3)).

When receiving the local BV, the resource manager 201 transmits the resource request including the local BV to the resource request and return receiver 116 of the global optimization mechanism 110 (step (4)).

The resource request and return receiver 116 of the global optimization mechanism 110 receives the resource request including the local BV from the resource manager 201 of the local optimization mechanism of the business service 1, and outputs a calculation request of the global BV for the local BV to the BV recalculator 113 (step (5)). The BV recalculator 113 refers to the BV re-calculation policy table 1141 to calculate the global BV for the received local BV (step (6)). This processing will be explained in detail later. The BV recalculator 113 outputs the global BV to the resource request and return receiver 116 (step (7)), and the resource request and return receiver 116 outputs the resource request including the global BV to the allocation determination unit 117. The allocation determination unit 117 registers data relating to the resource request (the service ID (here, business service 1) of the business service of the requesting source, the number of requested resources, and the global BV at the request), and refers to the resource management table of the resource manager 115 to judge whether or not the allocation of the resource should be carried out for the resource request. Here, the allocation determination unit 117 judges that the resource allocated to the business service 2 to be confiscated, and the resource to be allocated to the business service of the requesting source of this resource request (step (8)). In this case, the resource ID of the resource for which the business service is switched, the global BV included in the resource request, the service ID of the confiscation source (here, business service 2), which is the service ID of the business service from which the resource is confiscated, and the service ID of the allocation destination (here, business service 1), which is the service ID of the business service of the transmission source of the resource request, are registered into the allocation change management table 1172.

In addition, the allocation determination unit 117 transmits a resource release request including the resource ID of the resource to be confiscated to the resource manager 201 in the local optimization mechanism of the business service (here, business service 2) identified by the service ID of the confiscation source (step (9)). The resource manager 201 in the local optimization mechanism of the business service 2 receives the resource release request including the resource ID of the resource to be confiscated from the global optimization mechanism 110, and registers the resource release of the resource (step (10)). In addition, the resource manager 201 outputs the BV calculation request to the BV calculator 203 (step (11)). The BV calculator 203 receives the BV calculation request from the resource manager 201 to carry out the BV calculation (step (12)). Then, the BV calculator 203 outputs the local BV of the calculation result to the resource manager 201 (step (13)). The resource manager 201 receives the local BV from the BV calculator 203, and transmits the local BV update notification including the local BV, the resource ID and the service ID to the BV recalculator 113 of the global optimization mechanism 110 (step (14)).

The BV recalculator 113 of the global optimization mechanism 110 receives the local BV update notification from the local optimization mechanism of the business service 2, and carries out calculation of the global BV as described later (step (15)). Then, the BV recalculator 113 outputs the calculated global BV in addition to the service ID and the resource ID to the resource manager 115 (step (16)). The resource manager 115 updates the global BV of the pertinent record in the resource management table 1151 (step (17)).

In addition, the resource manager 201 in the local optimization mechanism of the business service 2 transmits a resource return notification including the resource ID to the allocation determination unit 117 through the resource request and return receiver 116 in the global optimization mechanism 110 (step (18)). Then, the allocation determination unit 117 causes the resource manager 115 to register the service ID (here, the business service 1) of the allocation destination and the BV at the request in association with the resource ID relating to the switching (FIG. 6B: step (19)). In addition, the pertinent records are invalidated in the resource request management table 1171 and the allocation change management table 1172. Then, the allocation determination unit 117 transmits the resource allocation notification to the resource manager 201 of the business service (here, the business service 1) relating to the service ID of the allocation destination (step (20)).

The resource manager 201 in the local optimization mechanism of the business service 1 receives the resource allocation notification from the global optimization mechanism 110, updates its own resource management table and outputs the BV calculation request to the BV calculator 203 (step (21)). The BV calculator 203 receives the BV calculation request from the resource manager 201 to carry out the BV calculation (step (22)). Then, the BV calculator 203 outputs the local BV of the calculation result to the resource manager 201 (step (23)). The resource manager 201 receives the local BV from the BV calculator 203, and transmits the local BV update notification including the local BV, the resource ID and the service ID to the BV recalculator 113 of the global optimization mechanism 110 (step (24)).

The BV recalculator 113 of the global optimization mechanism 110 receives the local BV update notification from the local optimization mechanism of the business service 1, and carries out the calculation of the global BV, which will be described later (step (25)). Then, the BV recalculator 113 outputs the calculated global BV in addition to the service ID and the resource ID to the resource manager 115 (step (26)). The resource manager 115 updates the global BV of the pertinent record in the resource management table 1151 (step (27)). By carrying out such a processing, the resource switching is carried out.

Incidentally, the processing flow shown in FIGS. 6A and 6B can be variously changed when the similar functions can be realized. For example, the steps (11) to (13) can be omitted. That is, it is possible to delete only the entry of the pertinent resource in the resource release at the step (10) from the resource management table of the local optimization mechanism without re-calculating the local BV of the resource to be released. In this case, the step (14) is changed to a step of notifying that the local BV is updated to a predetermined value, which means “the release of the resource”. In addition, the step (14) can be merged into the step (18). That is, it is possible to re-calculate the global BV of the pertinent resource when receiving the resource return notification (corresponding to the step (18)) (or it is possible to output a predetermined global BV, which should be assigned to a resource to which any service is allocated, and at that time, the steps (15) and (16) are also omitted), and to transmit only the resource return notification (step (18)) while omitting the local BV update notification (step (14)) of the released resource when updating the table of the resource manager 115 of the global optimization mechanism.

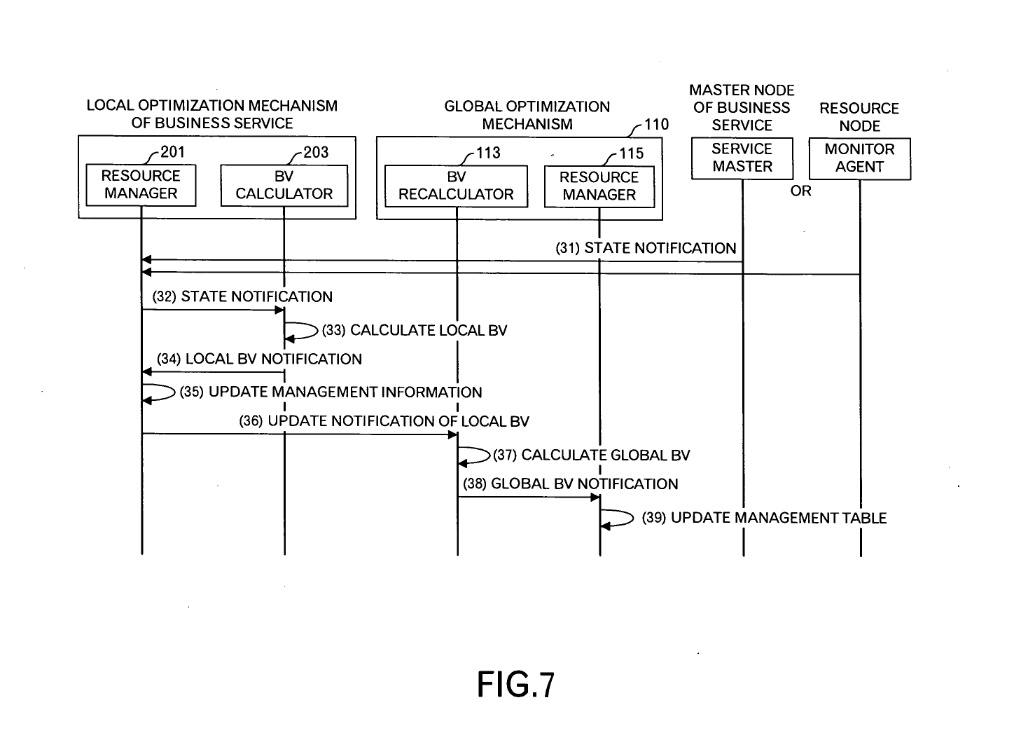

Although a scene is indicated in which the global BV is calculated from the local BV in the aforementioned processing, the global BV is also further calculated in the scene as shown in FIG. 7.

A monitor agent of each resource node or a service master in a master node of the business service, which collects notification from the monitor agents, transmits a state notification (e.g. including the number of sessions or the elapsed execution time) to the resource manager 201 in the local optimization mechanism of the business service, periodically or at the state change (step (31)). The resource manager 201 receives the state notification from the service master in the master node of the business service or the monitor agent of the allocated resource node, and outputs a local BV calculation request including the state notification to the BV calculator 203 (step (32)). The BV calculator 203 receives the local BV calculation request including the state notification and carries out calculation so as to update the local BV (step (33)). The BV calculator 203 notifies the resource manager 201 of the recalculated local BV (step (34)). The resource manager 201 updates its own management information (step (35)), and transmits a local BV update notification including the local BV, and the related resource ID and service ID to the BV recalculator 113 of the global optimization mechanism 110 (step (36)).

The BV recalculator 113 of the global optimization mechanism 110 receives the local BV update notification including the local BV, the resource ID and the service ID from the resource manager 201 in the local optimization mechanism of the business service, and carries out the calculation of the global BV from the local BV, which will be described in detail later (step (37)). Then, the BV recalculator 113 notifies the resource manager 115 of the global BV, the resource ID and the service ID (step (38)). The resource manager 115 receives the global BV, the resource ID and the service ID from the BV recalculator 113, and updates the pertinent record in the resource management table 1151 (step (39)).

Such a processing is repeated to update the global BV.

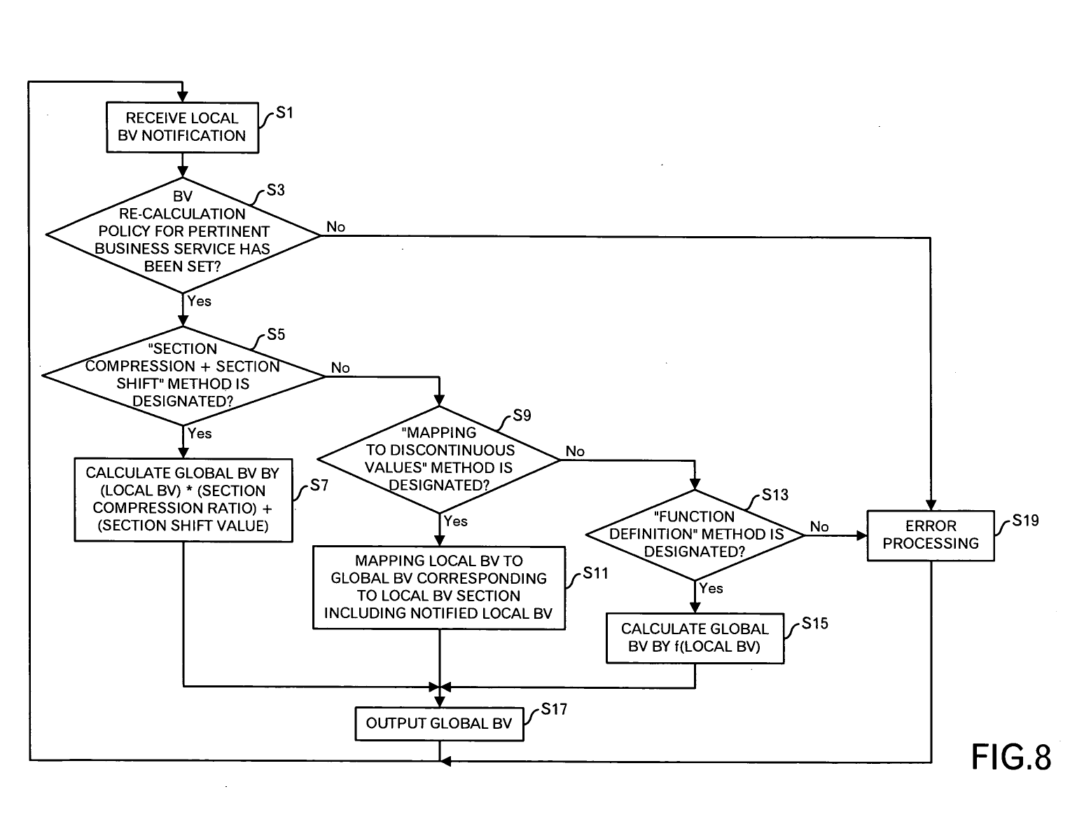

Next, the calculation of the global BV by the BV recalculator 113, for which the explanation was omitted in FIGS. 6A, 6B and 7 will be explained in detail by using FIGS. 8 to 13. First, the BV recalculator 113 receives the local BV update notification including the local BV, the resource ID and the service ID from the local optimization mechanism of any business service or receives the global BV calculation request including the local BV and the service ID from the resource request and return receiver 116, and stores the notification or the request into a storage device such as a main memory (step S1).

After that, the BV recalculator 113 refers to the BV re-calculation policy table 1141 of the BV re-calculation policy setting unit 114 to judge whether or not the BV re-calculation policy for the business service is set (step S3). That is, it is judged whether or not the record for the received service ID exists. Incidentally, even when the record for the received service ID exists, there is a case where “off” is set to the recalculation flag. In such a case, because the processing is carried out according to the input from the local BV distribution monitoring and adjustment unit 111 as described in detail later, the explanation more than this is omitted here. When there is no record for the received service ID, the BV recalculator 113 carries out a predetermined error processing because of the error (step S19). Then, the processing returns to the step S1.

On the other hand, when the record for the received service ID exists, the BV recalculator 113 judges whether or not a method of “section compression+section shift” is designated as the BV recalculation policy (step S5). This is judged by using data such as values of parameters (or graph/function) in the BV recalculation policy table 1141. When the method of “section compression+section shift” is adopted, the BV recalculator 113 calculates the global BV by ((the local BV)*(section compression ratio)+(section shift value)), for example, and stores the global BV into the storage device such as the main memory (step S7). However, the function is not limited to such a linear method of “compression and the section shift”. Then, the processing shifts to the step S17.

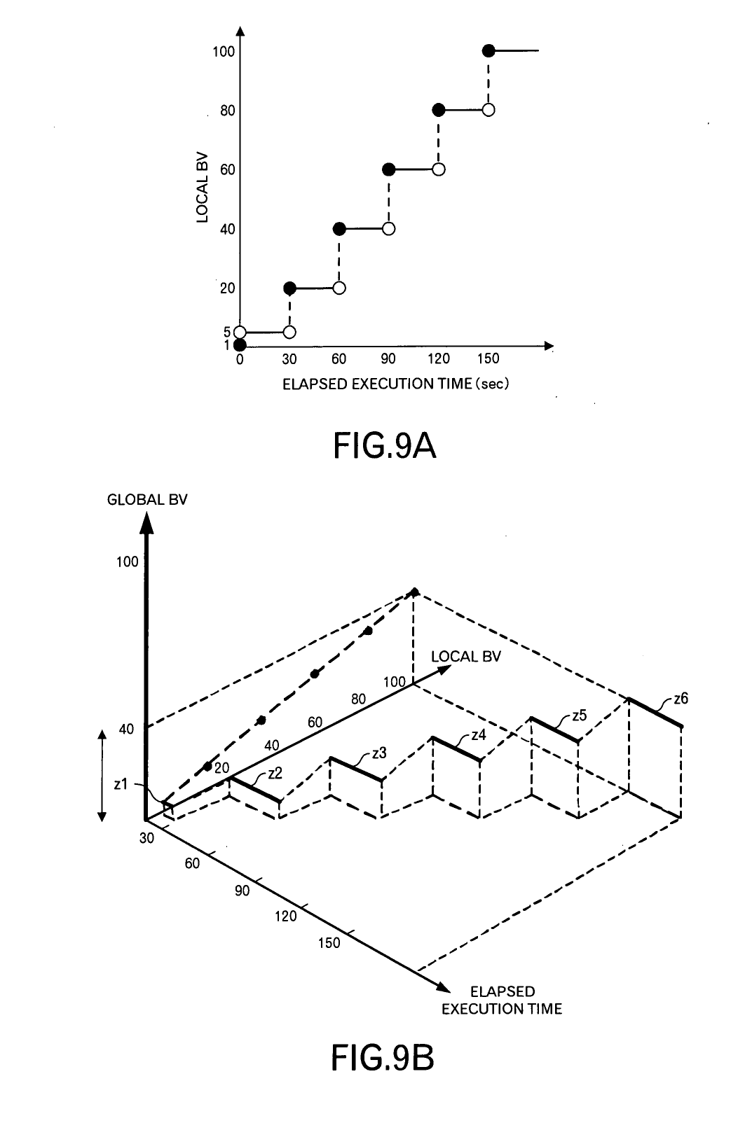

An example of the method of “section compression+section shift” is shown in FIGS. 9A and 9B. FIG. 9A represents the calculation carried out in the BV calculator 203 of the local optimization mechanism. Incidentally, the horizontal axis represents the elapsed execution time, and the vertical axis represents the local BV. For example, when the elapsed execution time is “0”, the local BV is “1”, when the elapsed execution time is less than “30”, the local BV is “5”, when the elapsed execution time is equal to or greater than “30” and less than “60”, the local BV is “20”, when the elapsed execution time is equal to or greater than “60” and less than 90, the local BV is “40”, when the elapsed execution time is equal to or greater than 90 and less than 120, the local BV is “60”, when the elapsed execution time is equal to or greater than 120 and less than 150, the local BV is “80”, and when the elapsed execution time is equal to or greater than 150, the local BV is “100”.

On the other hand, in FIG. 9B, the first axis represents the elapsed execution time, the second axis represents the local BV, and the third axis represents the global BV. The plane mapped by the first and second axes represents the calculation (FIG. 9A) carried out by the BV calculator 203 of the local optimization mechanism. On the other hand, the BV recalculator 113 of the global optimization mechanism 110 converts values 5, 20, 40, 60, 80 and 100 of the local BV to a straight line passing through the origin and having the inclination 1/2.5 like the straight line on the plane mapped by the second and third axes. That is, this is an example where the section of the local BV, which has the width of about 100, is compressed to the section of the global BV according to the section compression ratio 1/2.5, and is shifted by the section shift of “0”. Incidentally, the straight lines z1 to z6, which are represented by the thick lines, represent the relationship among the global BV, the local BV and the elapsed execution time in the three dimensional space.

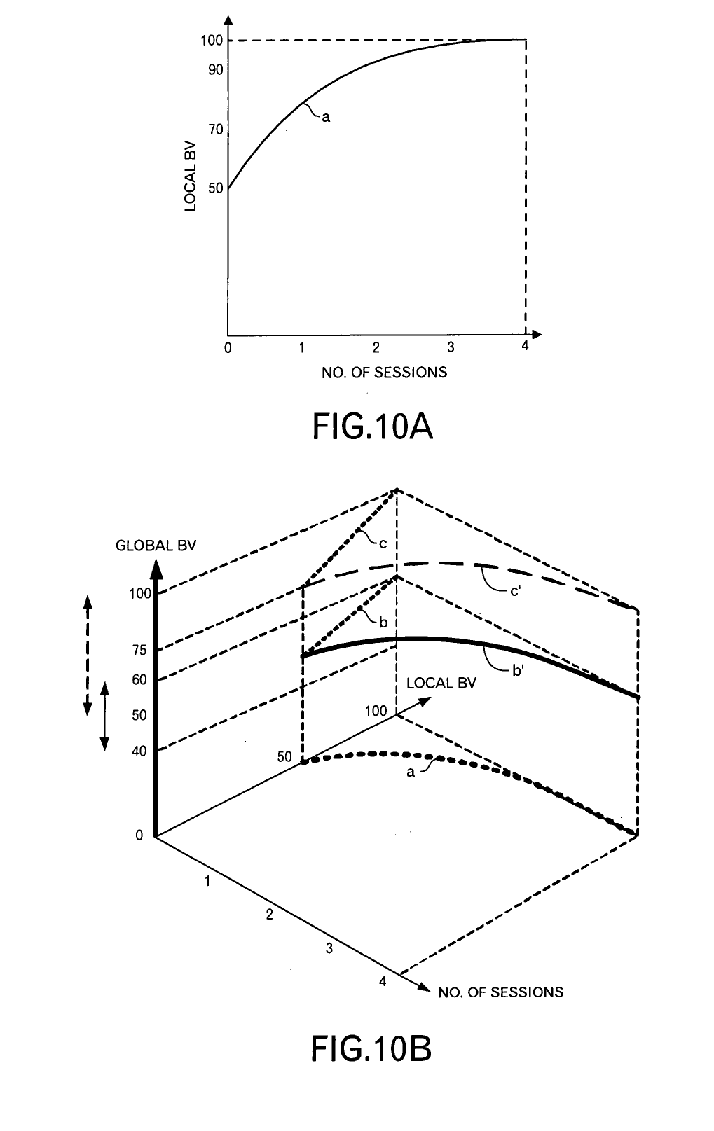

In addition, FIGS. 10A and 10B show an example of the method of “section compression+section shift”. FIG. 10A represents the calculation carried out by the BV calculator 203 of the local optimization mechanism. Incidentally, the horizontal axis represents the number of sessions, and the vertical axis represents the local BV. That is, the local BV is output in the width from 50 to 100 according to the number of sessions along with the curve a. On the other hand, in FIG. 10B, the first axis represents the number of sessions, the second axis represents the local BV, and the third axis represents the global BV. The plane mapped by the first and second axes represents the calculation (FIG. 10A) carried out by the BV calculator 203 of the local optimization mechanism. On the other hand, the BV recalculator 113 of the global optimization mechanism 110 carries out the section compression of the value of the local BV to the section from 40 to 60 of the global BV, and the section shift like the straight line b on the plane mapped by the second and third axes. That is, the section compression ratio is 1/5, and the section shift is 40. The curve b′ is a curve in the three dimensional space, directly representing the relationship among the number of sessions, the local BV and the global BV. In the case of the straight line c, the value of the local BV is converted to the section from 50 to 100 of the global BV by the section compression and the section shift. That is, the section compression ratio is 1/2, and the section shift is 50. The straight line c′ is a curve in the three dimensional space, directly representing the relationship among the number of sessions, the local BV and the global BV.

On the other hand, when it is judged at the step S5 that the “section compression+section shift” method is not designated, the BV recalculator 113 judges whether or not a method of “mapping to discontinuous values” is designated (step S9). This is judged by using data such as values of parameters (or graph/function) in the BV recalculation policy table 1141. When the method of “mapping to discontinuous values” is designated, the BV recalculator 113 carries out mapping to the global BV corresponding to the local BV section including the notified value (step S11). Then, the processing shifts to the step S17.

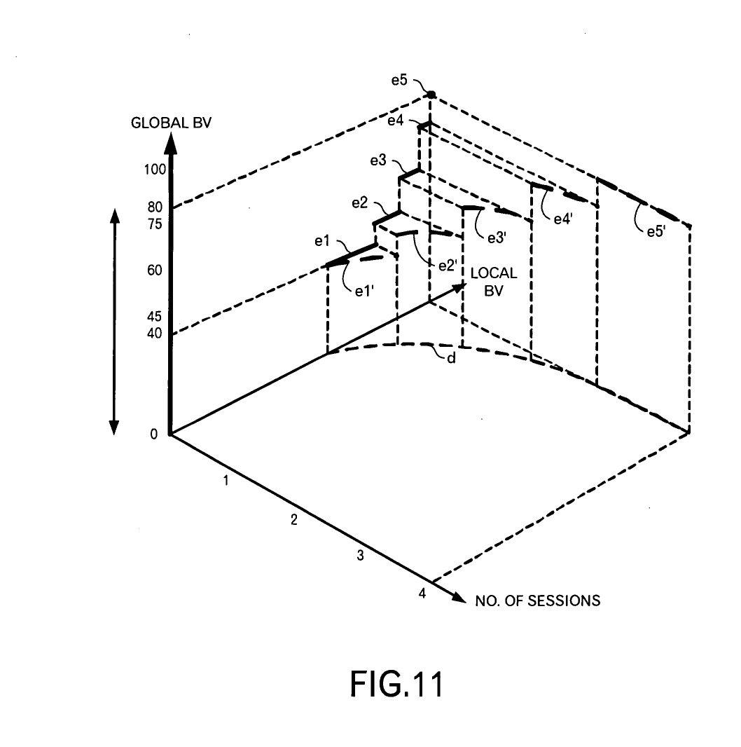

An example of the method of “mapping to discontinuous values” will be explained by using FIG. 11. In FIG. 11, the first axis represents the number of sessions, the second axis represents the local BV, and the third axis represents the global BV. The plane mapped by the first and second axes represents the calculation carried out by the BV calculator 113 of the local optimization mechanism, and the curve d, which is almost the same as the FIG. 10A, is used. On the other hand, the plane mapped by the second and third axes represents the calculation carried out by the BV recalculator 113 of the global optimization mechanism 110. Specifically, the section 1 (section from 50 to about 75 of the local BV) is converted to the straight line e1 of the global BV=40, the section 2 (section from about 75 to about 85 of the local BV) is converted to the straight line e2 of the global BV=45, the section 3 (section from about 85 to about 95 of the local BV) is converted to the straight line of the global BV=60, the section 4 (section from about 95 to a value less than 100 of the local BV) is converted to the straight line e4 of the global BV=75, and the section 5 (the local BV is 100) is converted to the point e5 of the global BV=80. Incidentally, the curve e1′ to e5′ represent the curve representing the relationship among the local BV, the global BV and the number of sessions in the three dimensional space.

On the other hand, when the method of “mapping to discontinuous values” is not designated, the BV recalculator 113 judges whether or not a “function definition” method is designated (step S13). In this step, the BV recalculator 113 judges by using data such as values of parameters (or graph/function) in the BV re-calculation policy table 1141. When the “function definition” method is designated, the BV recalculator 113 calculates the global BV by f(local BV) wherein the f(x) is a designated function (step S15). Then, the processing shifts to step S17.

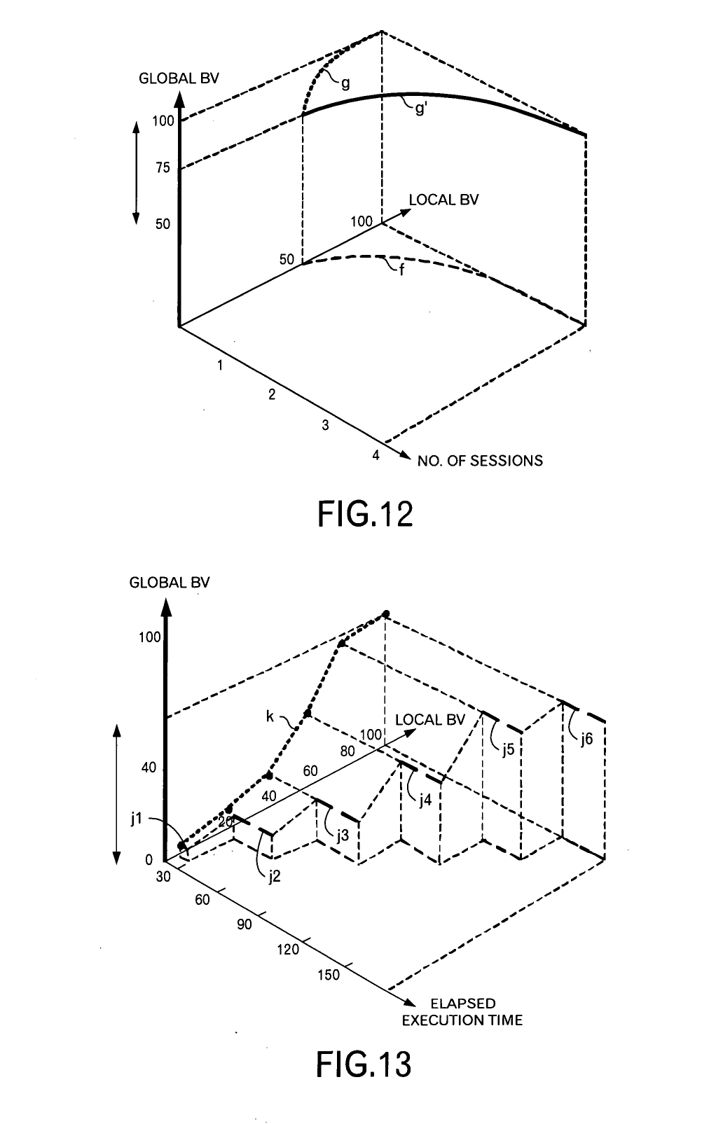

An example of the “function definition” method will be explained by using FIG. 12. In FIG. 12, the first axis represents the number of sessions, the second axis represents the local BV, and the third axis represents the global BV. The plane mapped by the first and second axes represents the calculation carried out by the BV calculator 203 of the local optimization mechanism, and the curve f, which is almost the same as FIG. 10A, is used. On the other hand, the plane mapped by the second and third axes represents the calculation carried out by the BV recalculator 113 of the global optimization mechanism 110. Specifically, the curve g corresponds to the function f(x). Incidentally, in the three dimensional space, the curve g′ represents the relationship among the local BV, the global BV and the number of session.

Another example of the “function definition” method will be explained by using FIG. 13. In FIG. 13, the first axis represents the elapsed execution time, the second axis represents the local BV, and the third axis represents the global BV. The plane mapped by the first and second axes represents the calculation carried out by the BV calculator 203 of the local optimization mechanism, and indicates the mapping to the discontinuous values, which is almost the same as the FIG. 9A. On the other hand, the plane mapped by the second and third axes represents the calculation carried out by the BV recalculator 113 of the global optimization mechanism 110. Specifically, the polygonal curve k corresponds to the function f(x). Incidentally, in the three dimensional space, the straight lines j1 to j6 represent the relationship among the local BV, the global BV and the elapsed execution time.

When it is judged at the step S13 that the “function definition” method is not designated, the processing shifts to step S19 in this embodiment. That is, an error processing is carried out. After the error processing, the processing returns to the step S1.

On the other hand, after the step S7, S11 or S15 is executed, the BV recalculator 113 outputs the global BV to the resource manager 115 to cause the resource manager 115 to update the resource management table 1151 (step S17). In case of the notification from the resource request and return receiver 116, the global BV is output to the resource request and return receiver 116. Then, the processing returns to the step S1.

By carrying out such a processing, it becomes possible to calculate the global BV by any one of the method of “section compression+section shift”, the method of “mapping to discontinuous values” and the “function definition” method according to the business service of the notification source. That is, the global BV is calculated independently of the calculation of the local BV in the BV calculator 203 of the local optimization mechanism and while considering the entire system to carry out the resource switching.

Incidentally, it is possible to dynamically change the calculation method of the global BV. In such a case, the BV re-calculation policy setting unit 114 registers two or more records into the BV re-calculation policy table 1141, and sets ON to the re-calculation flag for the valid record.

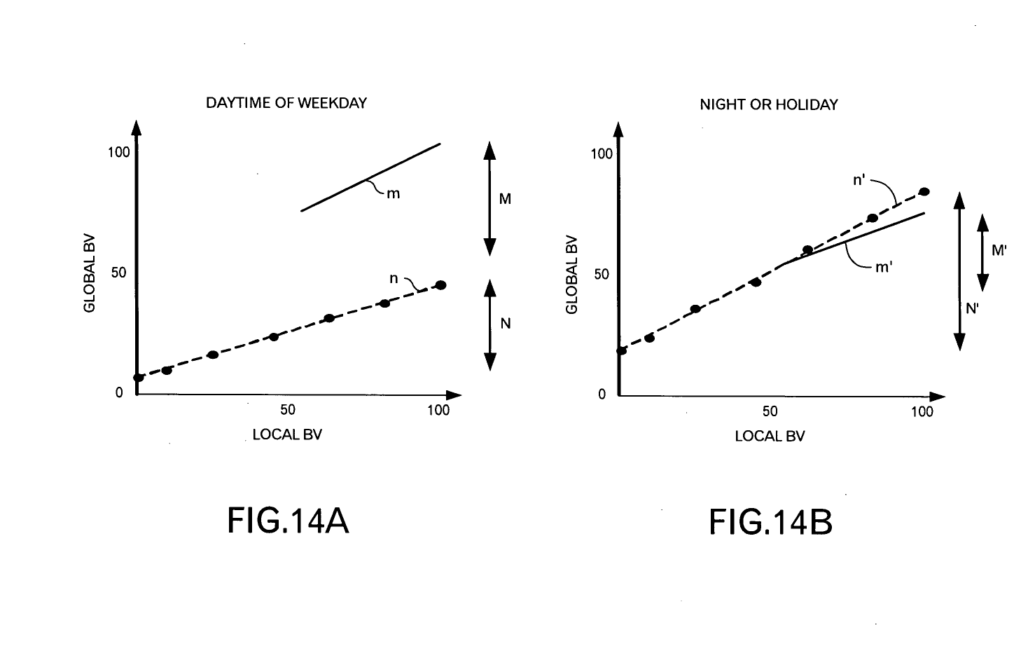

An example of dynamically changing the calculation method will be explained by using FIGS. 14A and 14B. In FIGS. 14A and 14B, the horizontal axis represents the local BV, and the vertical axis represents the global BV. For example, in the daytime of the weekday, as shown in FIG. 14A, the conversion represented by the straight line m is carried out for the first business service such as the videophone, and the global BV is distributed in the range M. On the other hand, the conversion represented by the straight line n is carried out for the second business service such as the batch job, and the global BV is distributed in the range N. Because the global BV of the first business service is relatively greater, the resource is allocated preferentially. On the other hand, in the night or the holiday, as shown in FIG. 14B, the conversion represented by the straight line m′ is carried out for the first business service, and the global BV is distributed in the range M′. The global BV of the straight line m′ is less than that of the straight line m, and the distribution range is also narrowed. On the other hand, the conversion represented by the straight line n′ is carried out for the second business service, and the global BV is distributed in the range N′. The global BV of the straight line n′ is greater than that of the straight line n, and the distribution range is also broadened. As for portions of the resources, the greater global BV is assigned to the second business service rather than the first business service.

Thus, the first business service, which consumes a lot of resources, is preceded in the daytime, and oppositely, the second business service is preceded by changing the values of the global BV in a time range when the number of use times of the batch processing is greater than that of the business service such as the videophone, such as the night of the weekday or the holiday. Therefore, more flexible and effective utilization of the system resources is enabled.

Incidentally, the switching of the BV re-calculation policy is not limited to two stages and it is possible to switch the policy in more stages. In addition, the switching may be carried out according to not only the reference relating to the time but also other references. For example, other references may be weather or a congestion state of the network.

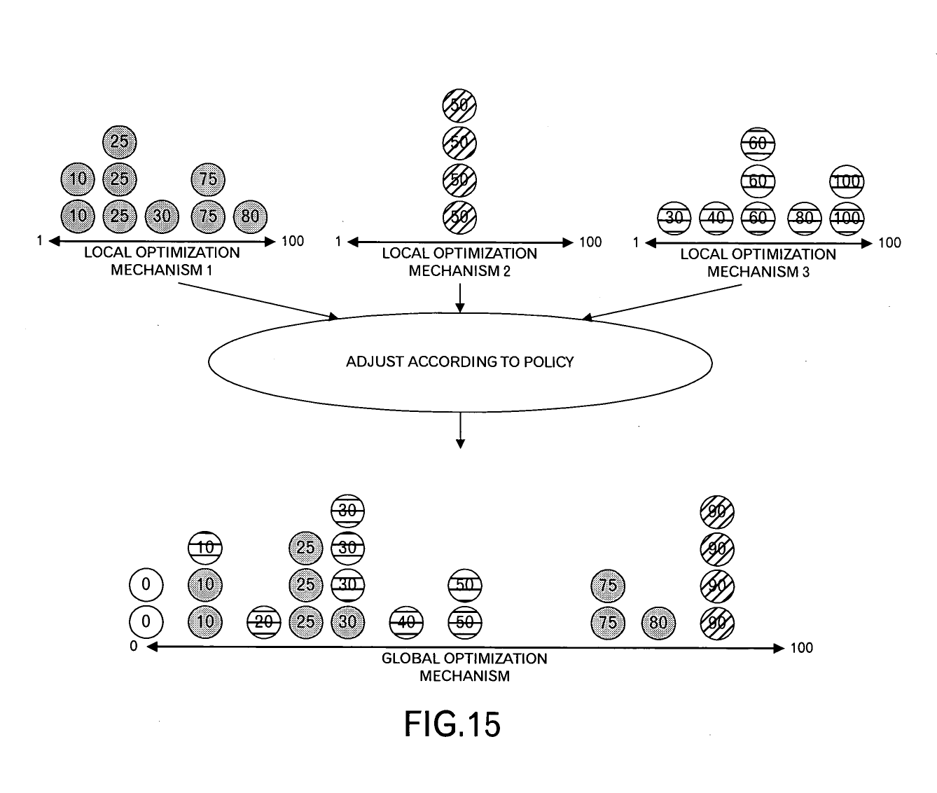

When summarizing the aforementioned explanation, the resource allocation is carried out as shown in FIGS. 15 to 19. Incidentally, it is assumed that the local optimization mechanisms 1 to 3 output the local BV from 1 to 100. As an initial state, as shown in the upper row of FIG. 15, the local optimization mechanism 1 of the business service 1 requests two resources for the services whose local BV is “10”, three resources for the services whose local BV is “25”, one resource for the service whose local BV is “30”, two resources for the services whose local BV is “75”, and one resource for the service whose local BV is “80”. In addition, the local optimization mechanism 2 of the business service 2 requests four resources for the services whose local BV is “50”. The local optimization mechanism 3 of the business service 3 requests one resource for the service whose local BV is “30”, one resource for the service whose local BV is “40”, three resources for the services whose local BV is “60”, and one resource for the service whose local BV is “80” and two resources for the services whose local BV is “100”. At that time, the BV recalculator 113 calculates the global BV according to the BV recalculation policy (the section compression ratio is 1, and the section shift value is 0) of the business service 1, which is stored in the BV re-calculation policy table 1141. In addition, the BV recalculator 113 calculates the global BV according to the BV re-calculation policy (the section compression ratio is 1.8, and the section shift is 0) of the business service 2, which is stored in the BV re-calculation policy table 1141. Furthermore, the BV recalculator 113 calculates the global BV according to the BV re-calculation policy (when the local BV is equal to or less than 30, the section compression ratio is 1/3, and the section shift value is 0, and when the local BV is greater than 30, the section compression ratio is 1/2, and the section shift value is 0) of the business service 3, which is stored in the BV re-calculation policy table 1141. Then, as shown in the lower row of FIG. 15, three resources are used for the services whose global BV is 10, one resource is used for the service whose global BV is 20, three resources are used for the services whose global BV is 25, four resources are used for the services whose global BV is 30, one resource is used for the service whose global BV is 40, two resources are used for the services whose global BV is 50, two resources are used for the services whose global BV is 75, one resource is used for the service whose global BV is 80, and four resources are used for the services whose global BV is 90. Incidentally, two unused resources, that is, to which global BV “0” is assigned, are remained.

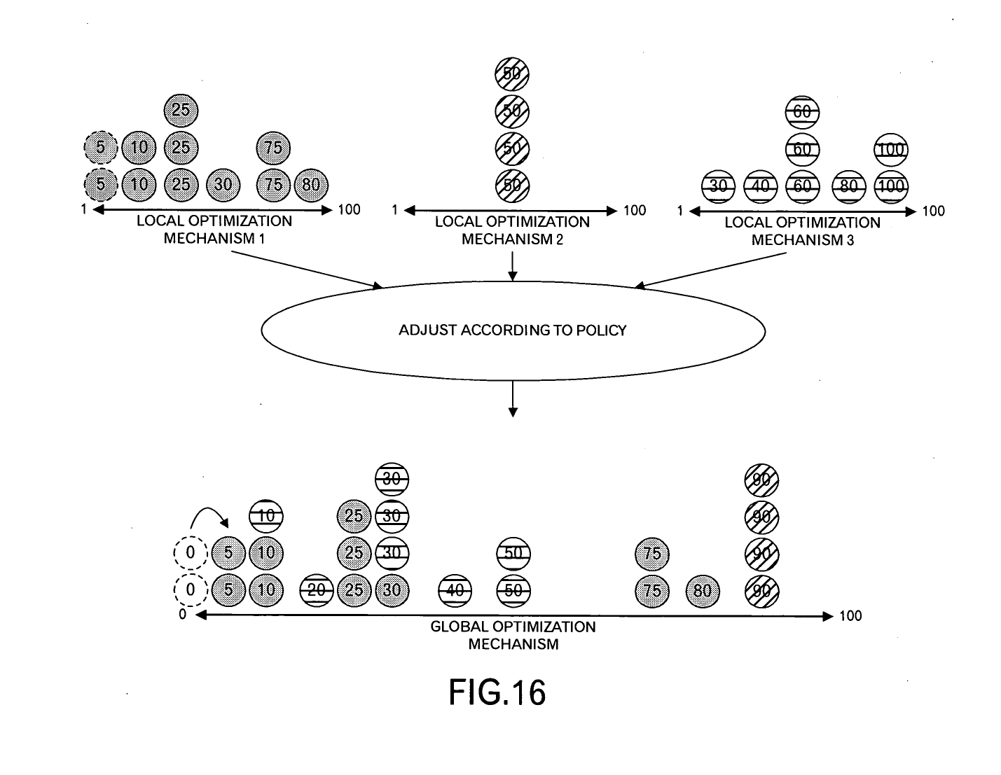

Next, in the state of FIG. 15, when it is considered that the local optimization mechanism 1 of the business service 1 requests two resources for the services whose local BV is 5, “5” is calculated as the global BV, and as shown in FIG. 16, two resources are secured for the services whose global BV is 5, and the unused resources disappear. In FIG. 16, the resources in the local optimization mechanism 1, in which the local BV is “5” and which are drawn by dotted lines, are obtained, and the resources in the global optimization mechanism 110, in which the global BV was “0” and which are drawn by dotted line, are allocated to the business service 1.

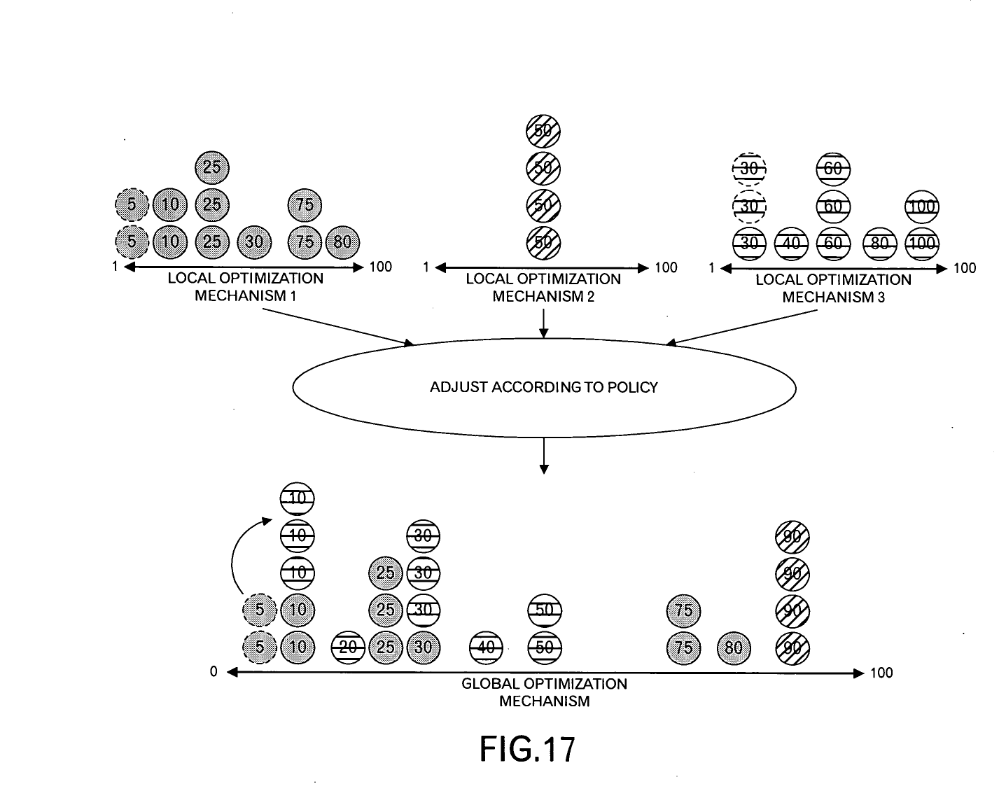

Furthermore, in the state of FIG. 16, when the local optimization mechanism 3 of the business service 3 requests two resources for the services whose local BV is 30, “10” is calculated as the global BV. Then, as shown in FIG. 17, two resources allocated to the business service 1, in which the global BV is 5, is transferred to the services whose global BV is 10, which is originated by the business service 3. In FIG. 17, the resources in the local optimization mechanism 3, in which the local BV is 30 and which are drawn by dotted lines, are obtained, the resources in the local optimization mechanism 1, in which the local BV is 5 and which are drawn by dotted lines, are confiscated, and the resources in the global optimization mechanism 110, in which the global BV is 5, and which are drawn by dotted lines, are allocated to the business service 3.

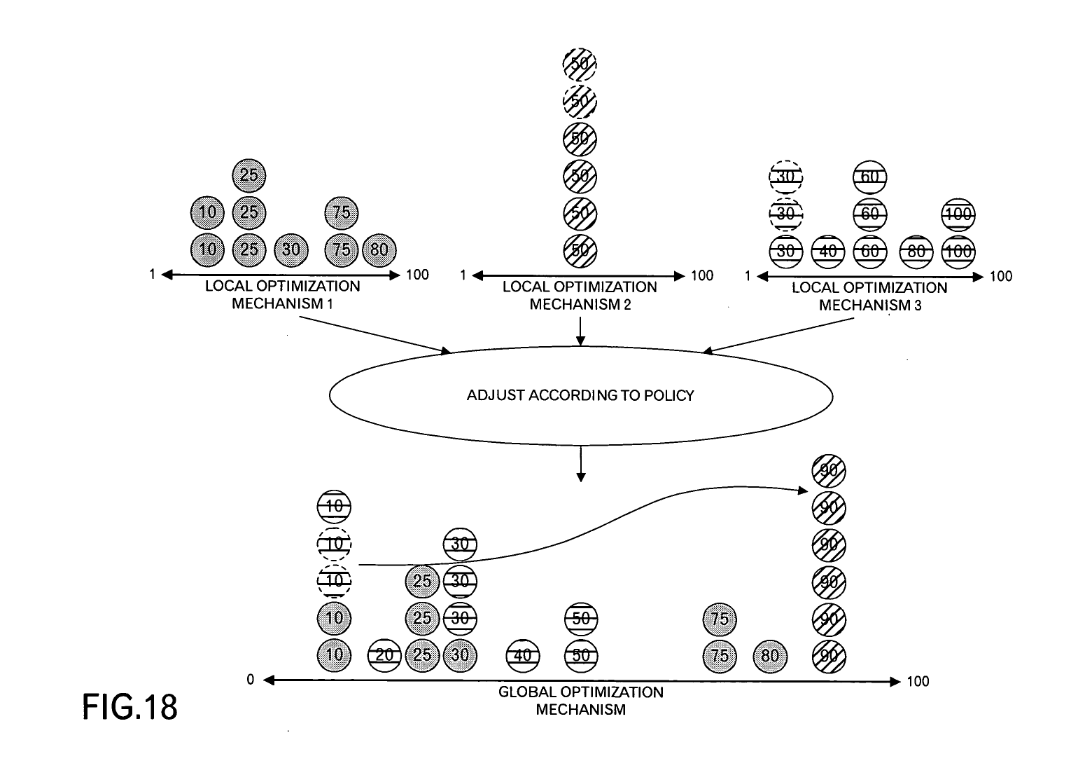

After that, in the state of FIG. 17, when the local optimization mechanism 2 of the business service 2 requests two resources for the services whose local BV is 50, “90” is calculated as the global BV. For example, it is assumed that the resource is preferentially allocated to the business service 1 when the same global BV is calculated. Then, as shown in FIG. 18, two resources allocated to the services of the business service 3, whose global BV is 10, is transferred to the services of the business service 2, whose global BV is 90. In FIG. 18, the resources in the local optimization mechanism 2, in which the local BV is 50, and which are drawn by dotted lines, are acquired, the resources in the local optimization mechanism 3, in which the local BV is 30, and which are drawn by dotted lines, are confiscated, and the resources in the global optimization mechanism 110 in which the global BV is 10 and which are drawn by dotted lines, are transferred to the services of the business service 3.

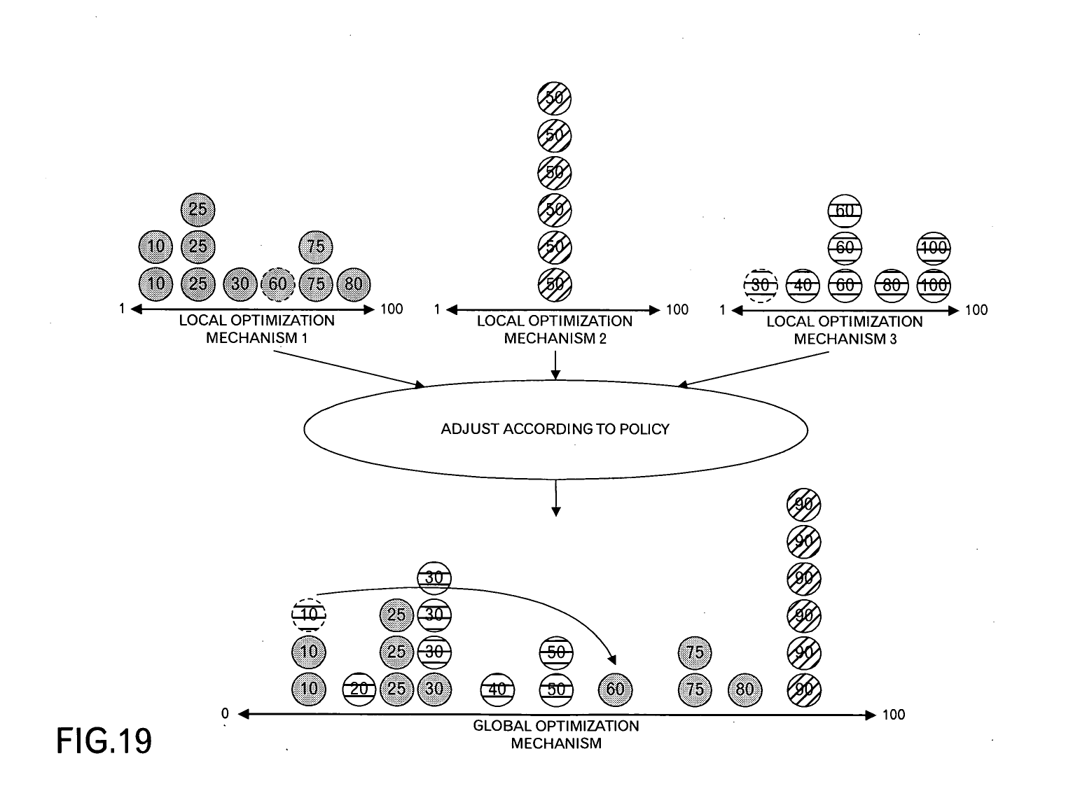

Furthermore, in the state of FIG. 18, when the local optimization mechanism 1 of the business service 1 requests one resource for the service whose local BV is 60, “60” is calculated as the global BV. For example, it is assumed that the resource is preferentially allocated to the business service 1 when the same global BV is calculated. Then, as shown in FIG. 19, the resource allocated to the service of the business service 3, whose global BV is 10, is transferred to the service of the business service 1, whose global BV is 60. In FIG. 19, the resource in the local optimization mechanism 1, in which the local BV is 60, and which is drawn by a dotted line, are obtained, the resource in the local optimization mechanism 3, in which the local BV is 30, and which is drawn by a dotted line, is confiscated, and the resource in the global optimization mechanism 110, in which the global BV is 10, and which is drawn by a dotted line, is transferred to the business service 1.

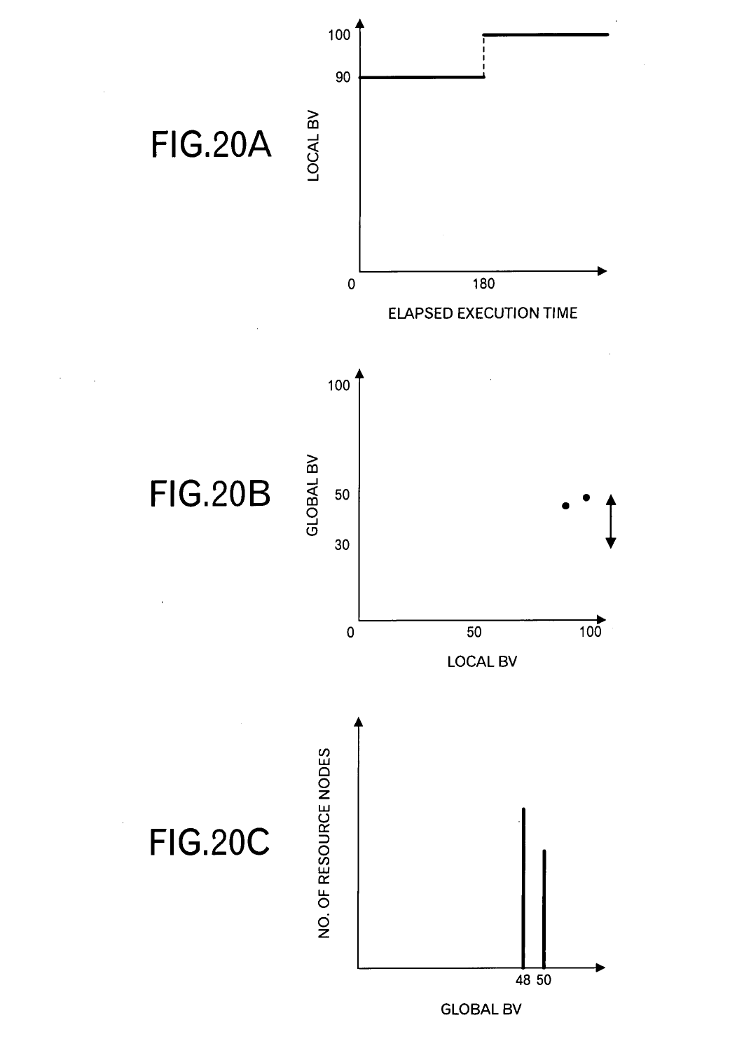

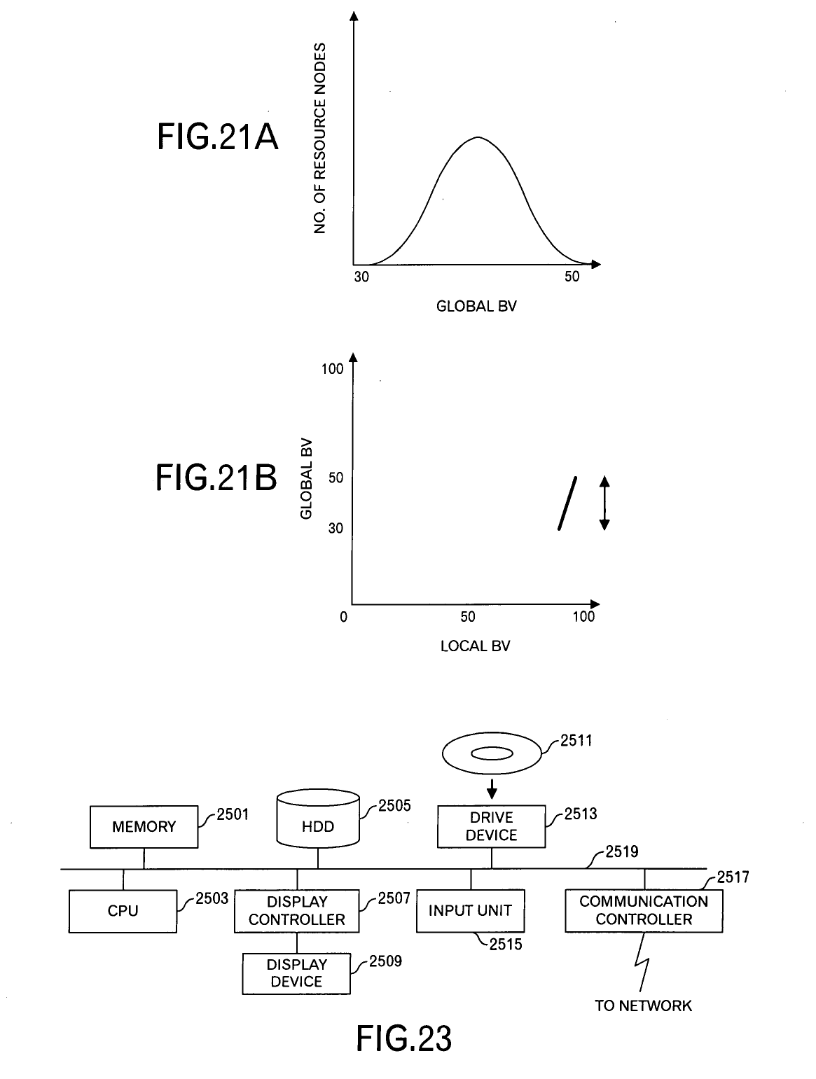

Next, a processing of the local BV distribution monitoring and adjustment unit 111 will be explained. For example, a case is considered where the administrator of the business service sets the policy as shown in FIG. 20A to the policy setting unit 202. That is, when the elapsed execution time is less than 180, the local BV is 90, and when the elapsed execution time is equal to or greater than 180, the local BV is 100. In such a case, even when the global BV is calculated according to the policy (e.g. the section compression ratio is 1/5, and the section shift value is 30) in the BV re-calculation policy table 1141 of the global optimization mechanism 110, only two values (e.g. 48 and 50) occur as shown in FIG. 20B. Of course, as shown in FIG. 20C, the distribution of the global BV is biased. Thus, when the setting so as to calculate the global BV too biasedly is carried out in the local optimization mechanism intentionally or carelessly, a case may occur where the resource is preferentially allocated to the business service in error, or adversely where the resource is not allocated to the business service completely. Therefore, it is preferable that the global BV is distributed in a predetermined range as wide as possible by the global optimization mechanism 110. For example, as shown in FIG. 21A, it is preferable that the global BV is calculated in the normal distribution from the lower limit 30 to the upper limit 50. In such a case, the relation between the local BV and the global BV is represented by the straight line (or curve) shown in FIG. 21B, not the points shown in FIG. 20B.

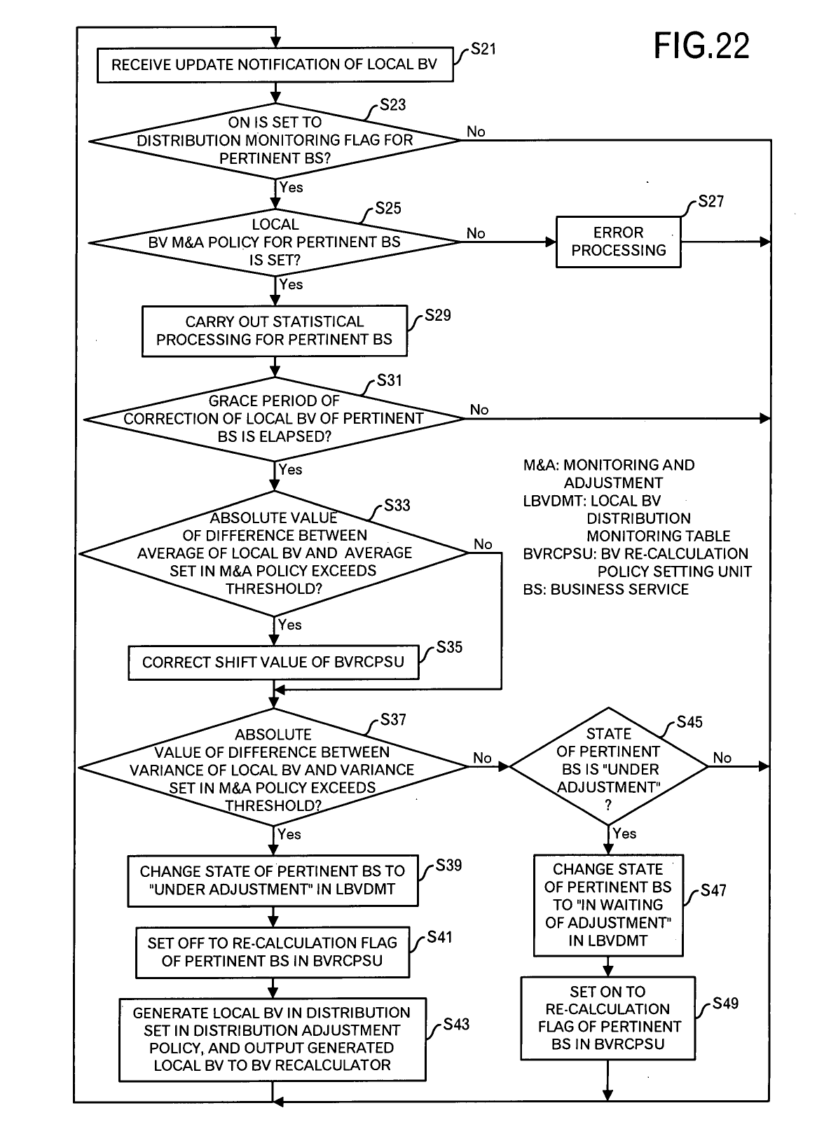

In order to adjust the distribution, the local BV distribution monitoring and adjustment unit 111 carries out a following processing. First, the local BV distribution monitoring and adjustment unit 111 receives the update notification of the local BV, which contains the local BV, the service ID and the resource ID, from the local optimization mechanism of the business service, and stores the update notification into the storage device such as the main memory (FIG. 22: step S21). Then, the local BV distribution monitoring and adjustment unit 111 refers to the distribution adjustment policy table 1121 to judge whether or not the distribution monitoring flag for the business service is “ON” (step S23). The local BV distribution monitoring and adjustment unit 111 searches the distribution adjustment policy table 1121 by the service ID, and identifies whether the distribution monitoring flag is ON or OFF. Then, when the distribution monitoring flag for the business service is OFF, the processing returns to the step S21.

On the other hand, when the distribution monitoring flag for the business service is ON, the local BV distribution monitoring and adjustment unit 111 judges whether or not the local BV monitoring and adjustment policy for the business service is set (step S25). The local BV monitoring and adjustment policy is specified by the distribution function in the distribution adjustment policy table 1121, parameters (average and variance) of the distribution function, the threshold of the average difference and the threshold of the variance difference. When the local BV monitoring and adjustment policy for the business service is not set, the local BV distribution monitoring and adjustment unit 111 carries out a predetermined error processing (step S27). Then, the processing returns to the step S21.

On the other hand, when the local BV monitoring and adjustment policy for the business service is set, the local BV distribution monitoring and adjustment unit 111 carries out a statistical processing, that is, calculation of the average and variance, and registers the processing result into the local BV distribution monitoring table 1111 (step S29). Furthermore, the local BV distribution monitoring and adjustment unit 111 judges from the grace period (time/the number of times) in the distribution adjustment policy table 1121 and the number of receipt times or count start time in the local BV distribution monitoring table 1111, whether or not the grace period of the correction of the local BV of the business service is elapsed (step S31). When the grace period is defined by the number of times, the local BV distribution monitoring and adjustment unit 111 judges whether or not the number of receipt times in the local BV distribution monitoring table 1111 exceeds the defined threshold. In addition, when the grace period is defined by time, the local BV distribution monitoring and adjustment unit 111 judges based on the difference between the count start time in the local BV distribution monitoring table 1111 and the current time, whether or not the grace period is elapsed.

When it is judged that the grace period of the correction of the local BV of the business service is not elapsed, the processing returns to the step S21. On the other hand, when it is judged that the grace period of the correction of the local BV of the business service was elapsed, the local BV distribution monitoring and adjustment unit 111 judges whether or not the absolute value of the difference between the average in the local BV distribution monitoring table 1111 and a parameter (i.e. the average) of the distribution function in the monitoring and adjustment policy defined in the distribution adjustment policy table 1121 exceeds the threshold of the average difference in the distribution adjustment policy table 1121 (step S33). When it is judged that the absolute value of the difference between the average in the local BV distribution monitoring table 1111 and the average set in the monitoring and adjustment policy does not exceed the threshold of the average difference, the processing shifts to step S37. Incidentally, when the thresholds include the upper limit and the lower limit, it is judged whether or not the difference is within a range specified by the upper limit and the lower limit.

On the other hand, when it is judged that the absolute value of the difference between the average in the local BV distribution monitoring table 1111 and the average set in the monitoring and adjustment policy exceeds the threshold of the average difference, the local BV distribution monitoring and adjustment unit 111 corrects the parameter value (e.g. the section shift value) for the pertinent business service in the BV re-calculation policy table 1141 of the BV re-calculation policy setting unit 114 by the difference between the average in the local BV distribution monitoring table 1111 and the average set in the monitoring and adjustment policy (step S35). {(the section shift value)−(the difference between the average in the local BV distribution monitoring table 1111 and the average set in the monitoring and adjustment policy)} is calculated and used for the correction. Other correction method may be adopted.

In case of No route at the step S33 or after the step S35, the local BV distribution monitoring and adjustment unit 111 judges whether or not the absolute value of the difference between the variance in the local BV distribution monitoring table 1111 and the parameter (i.e. variance) of the distribution function in the monitoring and adjustment policy defined in the distribution adjustment policy table 1121 exceeds the threshold of the variance difference in the distribution adjustment policy table 1121 (step S37). When it is judged that the absolute value of the difference between the variance in the local BV distribution monitoring table 1111 and the variance set in the monitoring and adjustment policy does not exceed the threshold of the variance difference, the processing shifts to step S45. Incidentally, when the thresholds include the upper limit value and the lower limit value, the local BV distribution monitoring and adjustment unit 111 judges whether or not the difference is out of the range specified by the upper limit value and the lower limit value.

On the other hand, when the absolute value of the difference between the variance in the local BV distribution monitoring table 1111 and the variance set in the monitoring and adjustment policy exceeds the threshold of the variance difference, the local BV distribution monitoring and adjustment unit 111 changes the state for the pertinent business service to “under adjustment” in the local BV distribution monitoring table 1111 (step S39). In addition, the local BV distribution monitoring and adjustment unit 111 causes the BV re-calculation policy setting unit 114 to set OFF to the re-calculation flag of the pertinent business service in the BV re-calculation policy table 1141 (step S41). Then, the local BV distribution monitoring and adjustment unit 111 generates the local BV in the distribution (the distribution function and parameters of the distribution function) set in the distribution adjustment policy table 1121, and outputs the local BV to the BV recalculator 113 (step S43). For example, a random number in the BV range (specified by the lower limit value and the upper limit value), which is defined in the BV re-calculation policy table, is generated. For example, when the normal distribution of N(μ, σ²) is designated, the normal random number is generated by the Box-Muller transform or the like, and the random number is generated in the BV range. Other distribution may be designated.

Incidentally, “OFF” may not be set to the re-calculation flag, but “1” may be set to the section compression ratio included in the parameters.

Then, the processing returns to the step S21.

On the other hand, when it is judged that the absolute value of the difference between the variance in the local BV distribution monitoring table 1111 and the variance set in the monitoring and adjustment policy does not exceed the threshold of the variance difference, the local BV distribution monitoring and adjustment unit 111 judges whether or not the state of the pertinent business service is “under adjustment” (step S45). When it is judged that the state of the pertinent business service is not “under adjustment”, the processing returns to the step S21. When it is judged that the state of the pertinent business service is “under adjustment”, the local BV distribution monitoring and adjustment unit 111 change the state of the pertinent business service to the “in waiting of the adjustment” in the local BV distribution monitoring table (step S47). In addition, the local BV distribution monitoring and adjustment unit 111 causes the BV re-calculation policy setting unit 114 to set ON to the re-calculation flag of the pertinent business service in the BV re-calculation policy table 1141 (step S49). Then, the processing returns to the step S21.

By carrying out the aforementioned processing, even when the distribution of the local BV is inappropriate, it is possible to appropriately correct the distribution. Therefore, an appropriate resource allocation is enabled.

Although the embodiment of this invention is explained, this invention is not limited to this embodiment. For example, the functional block diagrams shown in FIGS. 4 and 5A are mere examples, and the actual program modules do not always correspond to them.

In addition, as for the flowchart and the sequence diagram, when the same processing result can be obtained, the flowchart and the sequence diagram can be modified. For example, the order of the steps may be exchanged, and some steps may be executed in parallel.

Incidentally, the local optimization mechanism and the global optimization mechanism 110 are computer devices as shown in FIG. 23. That is, a memory 2501 (storage device), a CPU 2503 (processor), a hard disk drive (HDD) 2505, a display controller 2507 connected to a display device 2509, a drive device 2513 for a removal disk 2511, an input device 2515, and a communication controller 2517 for connection with a network are connected through a bus 2519 as shown in FIG. 28. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this invention, the application program to realize the aforementioned functions is stored in the removal disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application program are systematically cooperated with each other, so that various functions as described above in detail are realized.

The local optimization mechanism and the global optimization mechanism 110 may be implemented in separate computers and may be implemented in the same computer.

Although the present invention has been described with respect to a specific preferred embodiment thereof, various change and modifications may be suggested to one skilled in the art, and it is intended that the present invention encompass such changes and modifications as fall within the scope of the appended claims.

What is claimed is:

1. A method for calculating an importance degree for a resource, comprising:
receiving a first importance degree assigned to a resource node to be allocated or having been allocated to a specific business service based on an original policy in said specific business service; and
converting the received first importance degree to a second importance degree in an entire system according to data concerning an importance degree re-calculation policy, which is set for said specific business service, independently of said original policy.

2. The method as set forth in claim 1, further comprising:
switching said importance degree re-calculation policy for said specific business service.

3. The method as set forth in claim 1, wherein said importance degree re-calculation policy is at least one of a method for causing to carry out a section compression and a section shift, a method for mapping values to discontinuous predetermined values, and a method using a predetermined function.

4. The method as set forth in claim 1, wherein said importance degree re-calculation policy includes a rule concerning a range of said second importance degree.

5. The method as set forth in claim 1, further comprising:
judging whether or not distribution of the received first importance degrees is deviated from a reference, which is defined in advance; and
when it is judged that said distribution of the received first importance degrees is deviated from said reference, correcting said distribution of the received first importance degrees.

6. The method as set forth in claim 5, wherein said correcting comprises:
invalidating said importance degree re-calculation policy; and
correcting the received first importance degree so that the corrected first importance degrees distribute according to predefined distribution.

7. The method as set forth in claim 5, wherein said correcting comprises:
when a difference between an average value of the received first importance degrees and a predefined reference is equal to or greater than a predetermined value, correcting the received first importance degree according to said difference.

8. A program for causing a computer to calculate an importance degree for a resource, said program comprising:
receiving a first importance degree assigned to a resource node to be allocated or having been allocated to a specific business service based on an original policy in said specific business service; and
converting the received first importance degree to a second importance degree in an entire system according to data concerning an importance degree re-calculation policy, which is set for said specific business service, independently of said original policy.

9. The program as set forth in claim 8, further comprising:
switching said importance degree re-calculation policy for said specific business service.

10. The program as set forth in claim 8, wherein said importance degree re-calculation policy is at least one of a method for causing to carry out a section compression and a section shift, a method for mapping values to discontinuous predetermined values, and a method using a predetermined function.

11. The program as set forth in claim 8, wherein said importance degree re-calculation policy includes a rule concerning a range of said second importance degree.

12. The program as set forth in claim 8, further comprising:
judging whether or not distribution of the received first importance degrees is deviated from a reference, which is defined in advance; and
when it is judged that said distribution of the received first importance degrees is deviated from said reference, correcting said distribution of the received first importance degrees.

13. The program as set forth in claim 12, wherein said correcting comprises:
invalidating said importance degree re-calculation policy; and
correcting the received first importance degree so that the corrected first importance degrees distribute according to predefined distribution.

14. The program as set forth in claim 12, wherein said correcting comprises:
when a difference between an average value of the received first importance degrees and a predefined reference is equal to or greater than a predetermined value, correcting the received first importance degree according to said difference.

15. An apparatus for calculating an importance degree for a resource, comprising:
a unit that receives a first importance degree assigned to a resource node to be allocated or having been allocated to a specific business service based on an original policy in said specific business service; and
a unit that converts the received first importance degree to a second importance degree in an entire system according to data concerning an importance degree re-calculation policy, which is set for said specific business service, independently of said original policy.

16. The apparatus as set forth in claim 15, wherein said importance degree re-calculation policy is at least one of a method for causing to carry out a section compression and a section shift, a method for mapping values to discontinuous predetermined values, and a method using a predetermined function.

17. The apparatus as set forth in claim 15, wherein said importance degree re-calculation policy includes a rule concerning a range of said second importance degree.

18. The apparatus as set forth in claim 15, further comprising:
a unit that judges whether or not distribution of the received first importance degrees is deviated from a reference, which is defined in advance; and
a correction unit that corrects, when it is judged that said distribution of the received first importance degrees is deviated from said reference, said distribution of the received first importance degrees.

19. The apparatus as set forth in claim 18, wherein said correction unit comprises:
a unit that invalidates said importance degree re-calculation policy; and
a unit that corrects the received first importance degree so that the corrected first importance degrees distribute according to predefined distribution.

20. The apparatus as set forth in claim 18, wherein said correction unit comprises:
a unit that corrects, when a difference between an average value of the received first importance degrees and a predefined reference is equal to or greater than a predetermined value, the received first importance degree according to said difference.
